(19) United States
(12) Patent Application Publication
(10) Pub. No.: US 2007/0015424 A1
(43) Pub. Date: Jan. 18, 2007

(54) Building material having adaptive vapor retarder

(75) Inventors: Murray S. Toas, Norristown, PA (US); Lucas J. Hamilton, Philadelphia, PA (US)

Correspondence Address: DUANE MORRIS, LLP;IP DEPARTMENT, 30 SOUTH 17TH STREET, PHILADELPHIA, PA, 19103-4196, US

(73) Assignee: CertainTeed Corporation

(21) Appl. No.: 11/182,383

(22) Filed: Jul. 15, 2005

(51) Int. Cl. B32B 5/02

(52) U.S. Cl. 442/59; 442/164; 442/152; 442/221; 442/226

(57) ABSTRACT

A laminated article includes a substrate of a building material; and an adaptive vapor retarder film adhered to the substrate. The film is selected as being at least one from the group consisting of: ethylene vinyl alcohol (EVOH), EVOH coextruded or laminated with at least a second polymer, a blended polymer comprising EVOH, or a combination of these materials.

### FIELD OF THE INVENTION

The present invention relates to a laminated article which includes a building material adhered with an adhesive to a water vapor retarder film having a permeance dependent on the ambient humidity and a method of manufacturing the same.

### BACKGROUND

Building materials, such as fiber insulation batts and fiber insulation slabs attached to a facing material are known. For example, U.S. Pat. No. 5,848,509 describes an encapsulated insulation assembly in which a fiber insulation batt and a polymer film are moved along a longitudinal path and adhered to each other.

In many instances of manufacture, the facing materials used are kraft paper with an asphalt or bituminous coating and other polymeric materials to provide both support for the underlying fibers and to provide a liquid water and/or water vapor retarder.

A smart vapor retarder can be used as sheeting for covering insulation materials installed in wall and ceiling cavities. A build-up of excess moisture in the insulation is avoided by allowing the excess moisture to escape by vapor diffusion through the film thickness of the vapor retarder. A smart vapor retarder is a coating or film formed by a material, a polyamide, for example, that changes its water moisture vapor permeability in direct relationship with increases and/or decreases of the ambient humidity conditions. This transformation allows drying to occur through the process of vapor diffusion, thereby improving the speed of drying of the insulation and building materials. The film allows trapped moisture to escape, thereby alleviating a consequent formation of mold and water damage typically resulting from excess trapped moisture.

For example, U.S. Patent Application Publication No. 2004/0103603, which is incorporated by reference herein, describes the attachment of a vapor retarder, such as polyamide films, to insulation or other building materials such as gypsum board, particle board, etc. This vapor retarder imparts a water vapor diffusion resistance, permeance and/or transmission which depend on the ambient humidity.

One disadvantage of a smart vapor retarder is that the material cost may be higher than a conventional vapor retarder. For example, a polyamide material cost may be approximately three times the material cost of an inexpensive water vapor retarder material, such as, polyethylene. The higher material cost is a disincentive for the construction industry to use a smart vapor retarder, instead of using a less costly, vapor barrier film of polyethylene having little water vapor diffusion properties. Accordingly, it would be advantageous for a smart vapor retarder to have a reduced material content, which would reduce the material cost, and serve as an incentive for the construction industry to use a smart vapor retarder.

One proposed technique for reducing the material cost of a smart vapor retarder is to reduce its film thickness. However, test results have shown that the permeability of polymer films increase as the film thickness decreases. Thus, an attempt to reduce material content by reducing the film thickness, would detrimentally increase the permeability of the film, and the film would be unable to meet an insulation industry standard permeance of less than 1 when tested in accordance with ASTM E-96 “Standard Test Method for Water Vapor Transmission of Materials” Procedure A desiccant-dry cup method.

### SUMMARY OF THE INVENTION

In some embodiments, a laminated article includes a substrate of a building material; and an adaptive vapor retarder film adhered to the substrate, the film selected as being at least one from the group consisting of: ethylene vinyl alcohol (EVOH), EVOH coextruded or laminated with at least a second polymer, a blended polymer comprising EVOH, or a combination thereof.

In some embodiments, a laminated article comprises: a batt or blanket of a mineral fiber insulating material and an adaptive vapor retarder film adhered to the substrate. The film is at least one of: ethylene vinyl alcohol (EVOH), polyvinyl alcohol (PVOH), a layer of EVOH or PVOH, the layer coextruded or laminated with one or more of nylon or ethylene vinyl acetate (EVA) or polyethylene or polypropylene or polyester or polycarbonate or polyurethane or polyvinyl chloride (PVC), EVA coextruded with Nylon, a blended polymer film comprising EVOH or PVOH, or a combination thereof.

In some embodiments, a method comprises installing an adaptive vapor retarder in a wall, floor or ceiling of a building. The adaptive vapor retarder includes at least one of: an ethylene vinyl alcohol (EVOH) film, a layer of EVOH coextruded or laminated with at least a second polymer, a blended polymer film comprising EVOH; or a combination thereof.

In some embodiments, a composite article comprises: a substrate of a building material and an adaptive vapor retarder film fastened to the substrate. The film has a permeance of about 0.03 to about 0.5 U.S. perms in an ASTM E96 Procedure A Dry Cup test at 25% mean relative humidity and a permeance of at least 1 U.S. perm in an ASTM 96 Procedure B wet cup test at 75% mean relative humidity, and a thickness of about 0.0004″ to about 0.01″ (about 0.001 cm to about 0.025 cm). The film is made from a polymeric material which increases its water vapor permeability when exposed to increasing concentrations of water or water vapor.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1(A) is a diagrammatic elevation view showing one embodiment of the method and apparatus for manufacturing a laminated article according to the present invention. 1(B) is a diagrammatic view showing one embodiment of the pattern of adhesive application to the water vapor retarder film.

FIG. 2(A) is a diagrammatic elevation view showing another embodiment of the method and apparatus, including optional components, for manufacturing a laminated article according to the present invention. 2(B) is a diagrammatic view showing another embodiment of the vapor retarder film during the manufacturing process according to the invention.

FIG. 3 is a diagrammatic elevation view showing another embodiment of the method and apparatus for manufacturing a laminated article according to the present invention.

FIG. 4 is a diagram of an exemplary wall structure including an adaptive vapor barrier film.

FIG. 5 is a graph showing simulation results for the configuration of FIG. 4, wherein the adaptive vapor barrier is either polyamide or an ethylene vinyl alcohol/polypropylene/ethylene vinyl alcohol coextrusion or laminate.

FIG. 6 is a diagram of another exemplary wall structure including an adaptive vapor barrier film.

FIGS. 7 and 8 are graphs showing simulation results for the configuration of FIG. 6, wherein the adaptive vapor barrier is either polyamide or ethylene vinyl alcohol/polyester/ethylene vinyl alcohol laminate or ethylene vinyl alcohol/polypropylene/ethylene vinyl alcohol coextrusion or laminate.

FIG. 9 is a graph showing simulation results for the configuration of FIG. 4, wherein the adaptive vapor barrier is a coextrusion or laminate of EVOH and PVOH.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The present invention relates to an improved laminated article, such as a laminated building material, and a method of manufacturing the material, which can be performed at production speeds and which retains benefits of the permeance characteristics of the film component.

In an exemplary embodiment, a vapor-permeable film component comprises a smart vapor-permeable membrane, i.e., a membrane that changes its moisture vapor permeability with the ambient humidity condition. The film changes its water vapor permeability with the ambient humidity condition. Water vapor permeability may be measured by ASTM E96-00 “Standard Test Method for Water Vapor Transmission of Materials.” The film's permeance may be 1 perm or less when tested in accordance with ASTM E-96 Procedure A, dry cup method, although one exemplary EVA/Nylon/EVA (EVA=ethylene vinyl acetate) coextrusion has a calculated dry cup perm greater than 1. The film's permeance may increase to greater than 10 perms when tested using ASTM E-96 Procedure B the wet cup method. This process allows the building material to increase its drying potential dependent upon the presence of water, which consequently forms elevated levels of water vapor. The film reacts to relative humidity—which has significance in regard to building materials' endurance and susceptibility to mold growth when relative humidity increases above 60 percent—by increasing its water vapor permeability with increasing concentrations of moisture. This transformation allows drying to occur through the process of vapor diffusion, thereby improving the speed of drying of the insulation materials and other building components such as sheathing and framing lumber. The film allows trapped moisture to escape, thereby alleviating a consequent formation of mold and water damage typically associated with excess trapped moisture in the insulation and other building materials.

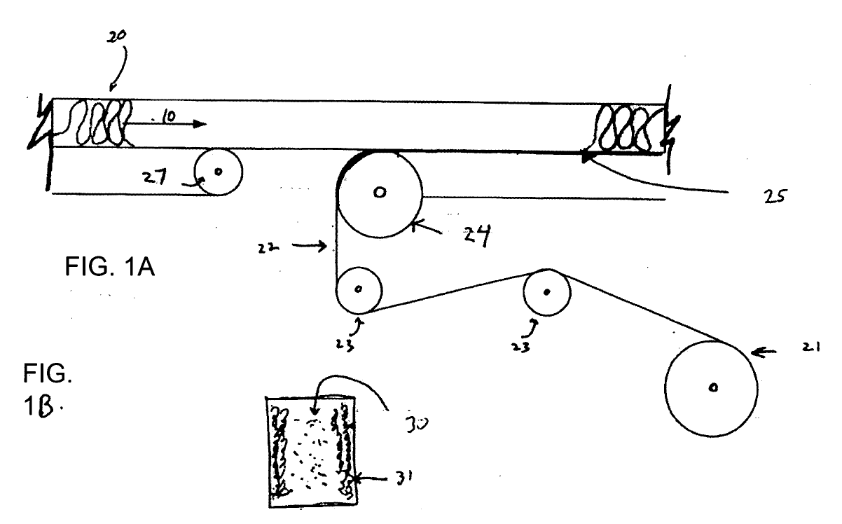

Referring to FIG. 1A, a building material 20 is fed through the process by a conveyer 27 in a predetermined linear path 10. The water vapor retarder film is provided on a roll 21 and also fed into the adhesion process via rollers 23. The thermoplastic, hot melt polymer adhesive is applied by a sprayer 22 and the water vapor retarder film partially coated with adhesive is joined with the building material to form a laminated article 25. In one embodiment, the roller 24 can be a heated roller to provide additional adhesive strength. In one aspect, the roller provides heat in an amount sufficient to keep the adhesive soft, and increase the bonding strength between the film and the building material. For example, for polypropylene-based hot melt adhesives, the roller is heated to at least about 350° F. Variations in heating temperature can be adjusted depending on the adhesive used, the bonding strength required, and the vapor retarder film used.

The water vapor retarder film component of the laminated article has a water vapor diffusion resistance, permeance, or transmission which is dependent on the ambient humidity and which has sufficient tensile strength for use in building and/or construction applications.

The thickness of the films will vary depending on the particular application, however, in exemplary embodiments, the film can be from 0.0004″ thick to 0.01″ thick.

In some embodiments, the film is a single layer of ethylene vinyl alcohol (EVOH) alone or polyvinyl alcohol (PVOH) alone. Tables 1 and 2, below, show properties of EVOH and PVOH films, and also present properties of ethylene vinyl acetate (EVA), Nylon, polyethylene, polypropylene, PVC, polycarbonate, polyurethane, and EVOH/Nylon coextruded films.

Table 1 includes ASTM E96 Procedure A Dry Cup Test data collected at 73 degrees F., 50% relative humidity (RH) in the test chamber, 0% RH in the cup, mean RH=25%, except that the first two rows (marked by the asterisks) are published values presented for comparison only. As is apparent from Table 1, the permeance varies with thickness, and also varies among different formulations of the same generic material (e.g., compare performance of the Soarus EVOH-29 and EVOH-44 films having a common thickness, where 29 and 44 signify the mole percentage of ethylene in the polymer molecule). The water vapor diffusion-equivalent air layer thickness in meters is a water vapor permeance term defined in International Standard ISO 12572 “Hygrothermal performance of building materials and products—Determination of water vapor transmission properties.” The tables include products sold by Honeywell International, Pottsville, Pa.; EVAL Company of America Houston, Tex.; Soarus, LLC, Arlington Heights, Ill.; Escorene by ExxonMobil, Baytown, Tex.; Clysar by Bemis Corporation Oshkosh, Wis.; Bovlon by Mitsui Plastics, White Plains, N.Y.; by SKC America, Inc., Covington, Ga.; by American Profol Inc., Cedar Rapids, Iowa; by Grafix Plastics, Cleveland, Ohio; by GE Polymershapes of Huntersville, N.C.; and by Deerfield Urethane, Inc of South Deerfield, Mass.

TABLE 1

| | | ASTM | |
|---|---|---|---|
| | Thickness | E96 Dry | |
| Plastic Film | (″) | Cup Perm | grams/24 h * m2 |
| Polyamide (U.S. Pat. No. 6808772)* | | 0.69 to 1.72 | 4.7 to 11.5 |
| Intello Product* | | 0.31 | 2.1 |
| (polyethylene copolymer membrane on | | | |
| polyethylene non-woven felt) | | | |
| Honeywell Capran ® 0.002″ thick Nylon 6 film | 0.002 | 0.76 | |
| not biaxially oriented | | | |
| Honeywell Capran ® Emblem ™ 2500 0.001″ | 0.001 | 1.10 | 7.6 |
| Biaxially Oriented Nylon | | | |
| Honeywell Capran ® Emblem ™ 1500 0.0006″ | 0.0006 | 1.64 | 11.0 |
| Biaxially Oriented Nylon | | | |
| Honeywell Capran ® Oxyshield ™ OXTR | 0.001 | 0.11 | 0.8 |
| machine direction oriented (coextrusion of | | | |
| Nylon and EVOH) | | | |
| Honeywell Capran ® Oxyshield ™ OBS | 0.00065 | 0.38 | 2.6 |
| machine direction oriented (coextrusion of | | | |
| Nylon and EVOH) | | | |
| EVAL EVOH EF-E 44 mole % ethylene | 0.0012 | 0.109 | 0.8 |
| Eval EVOH EF-CR 27 mole % ethylene | 0.0009 | 0.141 | 0.9 |
| Soarus EVOH-29 29 mole % ethylene | 0.0012 | 0.035 | 0.2 |
| Soarus EVOH 44 44 mole % ethylene | 0.0012 | 0.066 | 0.4 |
| ExxonMobil Escorene Ultra EVA LD719.93 | 0.0014 | 2.11 | 13.9 |
| 15% vinyl acetate copolymer | | | |
| ExxonMobil Escorene Ultra EVA LD720.01 | 0.0014 | 2.14 | 14.7 |
| 19.3% vinyl acetate copolymer | | | |
| ExxonMobil Escorene Ultra EVA LD767.mj | 0.0018 | 4.91 | 33.9 |
| 29.5% vinyl acetate copolymer | | | |
| Bemis Clysar LE Polyethylene | 0.0006 | 0.81 | 5.4 |
| Bovlon Poly Vinyl Alcohol | 0.0005 | 0.016 | 0.11 |
| GE Lexan FR83 Polycarbonate | 0.0032 | 1.24 | |
| Profol Polypropylene | 0.0013 | 0.16 | |
| SKC Polyester | 0.0014 | 0.40 | |
| Deerfield PT9200-US Polyurethane | 0.00093 | 18.89 | 129 |
| Grafix PVC | 0.0029 | 0.38 | 2.6 |

Table 2 includes ASTM E96 Procedure B Wet Cup Test data at 73F, 50% RH in the test chamber, 100% RH in the cup, mean RH=75%, except that the first two rows (marked by the asterisks) are published values presented for comparison only.

TABLE 2

| | | ASTM | |
|---|---|---|---|
| | | E96 Wet | |
| | Thickness | Cup | |
| Plastic Film | (″) | Perm | grams/24 h * m² |
| Polyamide (U.S. Pat. No. 6808772)* | | >3.45 | >24 |
| Intello Product* | | 3.45 | 24 |
| (polyethylene copolymer membrane on | | | |
| polyethylene non-woven felt) | | | |
| Honeywell Capran ® 0.002″ thick Nylon 6 film not | 0.002 | 11.90 | |
| biaxially oriented | | | |
| Honeywell Capran ® Emblem ™ 2500 0.001″ | 0.001 | 7.92 | 55.0 |
| Biaxially Oriented Nylon | | | |
| Honeywell Capran ® Emblem ™ 1500 0.0006″ | 0.0006 | 11.94 | 83.0 |
| Biaxially Oriented Nylon | | | |
| Honeywell Capran ® Emblem ™ 1200 0.00048″ | 0.0005 | 14.61 | 101.5 |
| Biaxially Oriented Nylon | | | |
| Honeywell Capran ® Oxyshield ™ OXTR machine | 0.001 | 5.09 | 35.3 |
| direction oriented (coextrusion of Nylon and | | | |
| EVOH) | | | |
| Honeywell Capran ® Oxyshield ™ OBS machine | 0.00065 | 3.88 | 27.0 |
| direction oriented (coextrusion of Nylon and | | | |
| EVOH) | | | |
| EVAL EVOH EF-E 44 mole % ethylene | 0.0012 | 0.95 | 6.7 |
| EVAL EVOH EF-CR 27 mole % ethylene | 0.0009 | 14.77 | 102.7 |
| Soarus EVOH 29 29 mole % ethylene | 0.0012 | 11.88 | 82.6 |
| Soarus EVOH 44 44 mole % ethylene | 0.0012 | 2.03 | 14.1 |
| ExxonMobil Escorene Ultra EVA LD719.93 15% | 0.0014 | 1.50 | 10.4 |
| vinyl acetate copolymer | | | |
| ExxonMobil Escorene Ultra EVA LD720.01 | 0.0014 | 1.32 | 9.1 |
| 19.3% vinyl acetate copolymer | | | |
| ExxonMobil Escorene Ultra EVA LD767.mj | 0.0018 | 3.54 | 24.6 |
| 29.5% vinyl acetate copolymer | | | |
| Bemis Clysar LE Polyethylene | 0.0006 | 0.57 | 4.0 |
| Bovlon Poly Vinyl Alcohol | 0.0005 | 25.83 | 179.4 |
| GE Lexan FR 83 Polycarbonate | 0.0032 | 0.98 | |
| Profol Polypropylene | 0.0013 | 0.20 | |
| SKC Polyester | 0.0014 | 0.33 | |
| Deerfield PT9200-US Polyurethane | 0.00093 | 25.12 | 174.5 |
| Grafix PVC | 0.0029 | 0.31 | 2.2 |

Table 3 includes test data from ASTM F1249 “Standard Test Method for Water Vapor Transmission Rate Through Plastic Film and Sheeting Using a Modulated Infrared Sensor” tests at=40° C., 0% RH in Cup 90% RH in the test chamber; therefore the mean RH=45%, except that the last row (marked by the asterisk) contains a published value presented for comparison only. This ASTM F1249 test is equivalent to Japanese Test Method JIS K 7129 Testing methods for water vapor transmission rate of plastic film and sheeting (instrument method).

TABLE 3

| | Thickness | grams/ |
|---|---|---|
| Film | (″) | m² * 24 hr |
| Honeywell Capran ® 0.002″ thick | 0.002 | 68.0 |
| Nylon 6 film | | |
| Honeywell Capran ® Oxyshield ™ | 0.001 | 37.7 |
| OXTR | | |
| machine direction oriented (coextrusion | | |
| of Nylon and EVOH) | | |
| Honeywell Capran ® Oxyshield ™ OBS | 0.00065 | 62.4 |
| machine direction oriented (coextrusion | | |
| of Nylon and EVOH) | | |
| EVAL EVOH EF-E 44 mole % | 0.0012 | 13.4 |
| ethylene | | |
| EVAL EVOH EF-CR 27 mole % | 0.0009 | 115 |
| ethylene | | |
| Soarus EVOH 29 29 mole % ethylene | 0.0012 | 38.4 |
| Soarus EVOH 44 44 mole % ethylene | 0.0012 | 20.7 |
| Japanese Laid Open Patent Publication | | 127.5 |
| DuPont/MAG 2002-172739* | | |

Although films comprising EVOH, PVOH, Polyamide, EVA, and coextrusions or blends containing one of these materials may be used, films including EVOH have the following advantages:

1) One can tailor the permeance of the EVOH vapor retarder to a particular climate by using EVOH alone by changing the fraction of ethylene and fraction of alcohol functional groups of the EVOH polymer. Reducing the ethylene content and increasing the alcohol content increases the wet cup permeance much more than it increases dry cup permeance. EVOH's molecture structure is —(CH₂-CH₂)ₘ—(CH₂—CH—OH)n— where m is the number of ethylene groups with no alcohol functional groups and n is the number of ethylene groups with an alcohol functional group. EVOH is a random copolymer of ethylene and vinyl alcohol.

2) One can further tailor the permeance of the EVOH vapor retarder to a particular climate by coextruding or laminating the EVOH with other polymers or blending with other polymers. The coextrusion or laminate may contain two, three, four or more layers, as appropriate to achieve the desired properties.

Although the permeance range of PVOH can also be adjusted by coextruding or laminating with other polymers and by changing its thickness, it would not be adjusted by modifying its ethylene and alcohol content, because all of its ethylene groups have an alcohol group. That is what makes it polyvinyl alcohol. The chemical structure for PVOH is —(CH₂—CH—OH)n—

To lower the cost of a nylon smart vapor retarder, the polyamide film can be made in lesser thicknesses than 0.002 inch (0.05 mm). However, the water vapor permeability of the adaptive vapor barrier is also dependent, in part, upon the polyamide film thickness. Reducing the film thickness significantly, in an attempt to lower cost, would show a substantial increase in permeability of the film, and the film would be unable to provide a vapor retarder with the industry standard acceptance of 1 perm maximum rating at 25% mean relative humidity measured by ASTM E96 Procedure A Dry Cup Method

In some embodiments, an adaptive vapor barrier material is coextruded or laminated with another (preferably less expensive) material. For example, a coextruded film may include EVOH coextruded with Nylon (polyamide or PA) and/or ethylene vinyl acetate (EVA) and/or polyethylene (PE), and/or polypropylene, and/or PVOH; or ethylene vinyl acetate (EVA) coextruded with Nylon, or a laminated film may include EVOH laminated with polyester, or EVOH with PVC, or EVOH with polycarbonate, or EVOH with polyurethane. Alternatively, PVOH can be coextruded or laminated with another polymer, such as PE or nylon. The tables that follow include several materials that may be used as smart vapor retarders in exemplary embodiments, either alone or combined in a coextrusion, laminate or blend with other polymers.

Coextrusion is a form of a lamination technique, i.e., layers may be laminated by coextrusion, adhesive bonding, etc. In general, for the above materials, if two thermoplastics are compatible, they can be combined by coextrusion to form a composite or laminated by melting the surfaces of the layers in contact with one another and applying pressure. If the two thermoplastics are not compatible they can be made into a laminate by placing an adhesive between the incompatible layers. Use of a coextruded or laminated film provides the strength and cost advantage of the lower cost film (e.g., polyethylene or polypropylene) while still providing a range of permeance values at different levels of humidity.

In the coextruded and laminated films described below, the calculations are based on the equation:
Permeability of multilayer films: P_{T}=L_{T}/[(Lₐ/Pₐ)+(L_{b}/P_{b})+ . . . (Lₙ/Pₙ)]

where P is permeance and L is thickness, the subscript T indicates “Total”, and the other subscripts indicate individual layers. (See Kay Cooksey, Kenneth S. Marsh and Leroy H. Doar, “Predicting Permeability & Transmission Rate for Multilayer Materials”; Food Technology, September 1999, Vol. 53, No. 9, pages 60-63) Since a film's permeability is directly related to the film's thickness, for any given material, the calculated permeance of a second film having twice the thickness of a first film will be one half of the permeance of the first film. Also, since a film's permeability is directly related to the film's thickness, for any given material, the calculated permeance of a second film having one half the thickness of a first film will be two times the permeance of the first film.

Table 4 presents calculated permeance data of 0.0024″ thick EVOH, Soarus EVOH-29. These values are calculated based on the measured permeance of the same material in 0.0012 inch thickness (Tables 1 and 2).

TABLE 4

| | Thickness | ASTM E96 | grams/ | grams/ |
|---|---|---|---|---|
| | (″) | Perm | 24 h * 100 in2 | 24 h * m2 |
| Soarus | 0.0024 | 0.02 | 0.008 | 0.1 |
| EVOH-29 @ | | | | |
| mean 25% | | | | |
| RH | | | | |
| Soarus EVOH | 0.0024 | 5.9 | 2.7 | 41 |
| 29 @ mean | | | | |
| 75% RH | | | | |

Table 5 presents calculated permeance data for the Soarus EVOH-29 and EVOH-44 films for 0.0006 inch thickness, based on the measured data for 0.0012 inch thickness (Tables 1 and 2).

TABLE 5

| | Thickness | ASTM E96 | grams/ | grams/ |
|---|---|---|---|---|
| | (″) | Perm | 24 h * 100 in2 | 24 h * m2 |
| Soarus | 0.0006 | 0.07 | 0.032 | 0.5 |
| EVOH-29 @ | | | | |
| mean 25% | | | | |
| RH | | | | |
| Soarus EVOH | 0.0006 | 24 | 10.7 | 165 |
| 29 @ mean | | | | |
| 75% RH | | | | |
| Soarus EVOH | 0.0006 | 0.13 | 0.058 | 0.9 |
| 44 @ mean | | | | |
| 25% RH | | | | |
| Soarus EVOH | 0.0006 | 4.1 | 1.8 | 28 |
| 44 @ mean | | | | |
| 75% RH | | | | |

Table 6 presents calculated permeance data of 0.0006″ thick EVOH, EVAL EVOH EF-E 44 mole % ethylene. These values are calculated based on the measured permeance of the same material in 0.0012 inch thickness (Tables 1 and 2).

TABLE 6

| | | ASTM | | |
|---|---|---|---|---|
| | Thickness | E96 | grams/ | grams/ |
| | (″) | Perm | 24 h * 100 in2 | 24 h * m2 |
| Eval EVOH EF-E 44 | 0.0006 | 0.2 | 0.10 | 1.5 |
| mole % ethylene @ | | | | |
| mean 25% RH | | | | |
| Eval EVOH EF-E 44 | 0.0006 | 2 | 0.9 | 13 |
| mole % ethylene @ | | | | |
| mean 75% RH | | | | |

Table 7 presents calculated permeance data of 0.00045″ thick EVOH, Eval EVOH EF-CR 27 mole % ethylene. These values are calculated based on the measured permeance of the same material in 0.0009 inch thickness (Tables 1 and 2).

TABLE 7

| | | ASTM | | |
|---|---|---|---|---|
| | Thickness | E96 | grams/ | grams/ |
| | (″) | Perm | 24 h * 100 in2 | 24 h * m2 |
| Eval EVOH EF-CR | 0.00045 | 0.3 | 0.12 | 1.9 |
| @ mean 25% RH | | | | |
| EVAL EVOH EF-CR | 0.00045 | 30 | 13.3 | 205 |
| @ mean 75% RH | | | | |

Table 8 presents calculated permeance data of 0.001″ thick non biaxially oriented Nylon. These values are calculated based on the measured permeance of the same material in 0.002 inch thickness (Tables 1 and 2).

TABLE 8

| | | ASTM | | |
|---|---|---|---|---|
| | Thickness | E96 | grams/ | grams/ |
| | (″) | Perm | 24 h * 100 in2 | 24 h * m2 |
| 0.001″ thick Nylon | 0.001 | 1.5 | | |
| 6 film @ 25% | | | | |
| mean RH | | | | |
| 0.001″ thick Nylon | 0.001 | 24 | | |
| 6 film @ 75% | | | | |
| mean RH | | | | |

Table 9 presents calculated permeance data of 0.0009″ thick EVA, ExxonMobil Escorene Ultra EVA LD767.mj 29.5% vinyl acetate copolymer. These values are calculated based on the measured permeance of the same material in 0.0018 inch thickness (Tables 1 and 2). Note that EVA is not, by itself, considered an adaptive vapor retarder.

TABLE 9

| | | ASTM | | |
|---|---|---|---|---|
| | Thickness | E96 | grams/ | grams/ |
| | (″) | Perm | 24 h * 100 in2 | 24 h * m2 |
| ExxonMobil Escorene | 0.0009 | 9.8 | 4.4 | 67.9 |
| Ultra EVA LD767.mj | | | | |
| 29.5% vinyl acetate | | | | |
| copolymer @ 25% | | | | |
| Mean RH | | | | |
| ExxonMobil Escorene | 0.0009 | 7.1 | 3.2 | 49 |
| Ultra EVA LD767.mj | | | | |
| 29.5% vinyl acetate | | | | |
| copolymer @ 75% | | | | |
| Mean RH | | | | |

Table 10 presents calculated permeance data for a 0.0007 inch thick EVA ExxonMobil Escorene Ultra EVA LD719.93 15% vinyl acetate copolymer, based on the measured data for 0.0014 inch thickness (Tables 1 and 2). Note that EVA is not, by itself, considered an adaptive vapor retarder.

TABLE 10

| | Thickness | ASTM E96 | grams/ | Grams/ |
|---|---|---|---|---|
| | (″) | Perm | 24 h * 100 in2 | 24 h * m2 |
| ExxonMobil | 0.0007 | 4.2 | 1.8 | 28 |
| Escorene Ultra | | | | |
| EVA LD719.93 | | | | |
| 15% vinyl | | | | |
| acetate | | | | |
| copolymer @ | | | | |
| mean 25% RH | | | | |
| ExxonMobil | 0.0007 | 3 | 1.34 | 21 |
| Escorene Ultra | | | | |
| EVA LD719.93 | | | | |
| 15% vinyl | | | | |
| acetate | | | | |
| copolymer @ | | | | |
| mean 75% RH | | | | |

Table 11 presents calculated permeance data of 0.0003″ thick polyethylene, Bemis Clysar LE Polyethylene. These values are calculated based on the measured permeance of the same material in 0.0006 inch thickness (Tables 1 and 2). Note that polyethylene is not, by itself, considered an adaptive vapor retarder.

TABLE 11

| | | ASTM | | |
|---|---|---|---|---|
| | Thickness | E96 | grams/ | grams/ |
| | (″) | Perm | 24 h * 100 in2 | 24 h * m2 |
| Bemis Clysar LE | 0.0003 | 1.6 | 0.35 | 5.4 |
| Polyethylene @ 25% | | | | |
| Mean RH | | | | |
| Bemis Clysar LE | 0.0003 | 1.1 | 0.26 | 4 |
| Polyethylene @ 75% | | | | |
| Mean RH | | | | |

Table 12 presents calculated permeance data of 0.0016″ thick GE Lexan Polycarbonate. These values are calculated based on the measured permeance of the same material in 0.0032 inch thickness (Tables 1 and 2). Note that polycarbonate is not, by itself, considered an adaptive vapor retarder.

TABLE 12

| | | | |
|---|---|---|---|
| | ASTM | | |
| Thickness | E96 | Grams/ | grams/ |
| (″) | Perm | 24 h * 100 in2 | 24 h * m2 |

| | | |
|---|---|---|
| GE Lexan | 0.0016 | 2.5 |
| Polycarbonate @ 25% | | |
| Mean RH | | |
| GE Lexan | 0.0016 | 2 |
| Polycarbonate @ 75% | | |
| Mean RH | | |

Table 13 presents calculated permeance data of 0.00065″ thick Profol Superclear Polypropylene. These values are calculated based on the measured permeance of the same material in 0.0013 inch thickness (Tables 1 and 2). Note that polypropylene is not, by itself, considered an adaptive vapor retarder.

TABLE 13

| | | | |
|---|---|---|---|
| | ASTM | | |
| Thickness | E96 | Grams/ | grams/ |
| (″) | Perm | 24 h * 100 in2 | 24 h * m2 |

| | | |
|---|---|---|
| Profol Superclear | 0.00065 | 0.3 |
| Polypropylene @ 25% | | |
| Mean RH | | |
| Profol Superclear | 0.00065 | 0.4 |
| Polypropylene @ 75% | | |
| Mean RH | | |

Table 14 presents calculated permeance data of 0.0007″ thick SKC Polyester. These values are calculated based on the measured permeance of the same material in 0.0014 inch thickness (Tables 1 and 2). Note that polyester is not, by itself, considered an adaptive vapor retarder.

TABLE 14

| | | | |
|---|---|---|---|
| | ASTM | | |
| Thickness | E96 | Grams/ | grams/ |
| (″) | Perm | 24 h * 100 in2 | 24 h * m2 |

| | | |
|---|---|---|
| SKC Polyester @ 25% | 0.0007 | 0.8 |
| Mean RH | | |
| SKC Polyester @ 75% | 0.0007 | 0.7 |
| Mean RH | | |

Table 15 presents calculated permeance data of 0.0014″ thick Grafix PVC. These values are calculated based on the measured permeance of the same material in 0.0029 inch thickness (Tables 1 and 2). Note that PVC is not, by itself, considered an adaptive vapor retarder.

TABLE 15

| | | ASTM | | |
|---|---|---|---|---|
| | Thickness | E96 | Grams/ | grams/ |
| | (″) | Perm | 24 h * 100 in2 | 24 h * m2 |
| Grafix PVC @ 25% | 0.0014 | 0.8 | 0.34 | 5.3 |
| Mean RH | | | | |
| Grafix PVC @ 75% | 0.0014 | 0.6 | 0.28 | 2.2 |
| Mean RH | | | | |

Table 16 presents calculated permeance data for a coextruded Nylon/EVOH/Nylon film, based on the individual layer characteristics (Above).

TABLE 16

| | | | | | EVOH EF CR | |
|---|---|---|---|---|---|---|
| Total | Soarus EVOH 44 | | Nylon | | Layer 3 | |
| Thickness (″) | Layer 1 | | Layer 2 | | Thick- | |
| 0.0035 | Thickness | Perm | Thickness | Perm | ness | Perm |
| Total ASTM | 0.0006 | 0.13 | 0.002 | 0.76 | 0.0009 | 0.141 |
| Perms @ | | | | | | |
| mean 25% RH | | | | | | |
| 0.3 | | | | | | |
| Total ASTM | 0.0006 | 4.1 | 0.002 | 11.90 | 0.0009 | 14.77 |
| Perms @ | | | | | | |
| mean 75% RH 9 | | | | | | |

Table 17 presents calculated permeance data for a coextruded EVOH/EVA film, based on the individual layer characteristics (Above).

TABLE 17

| | | | ExxonMobil Escorene | |
|---|---|---|---|---|
| | | | Ultra EVA LD719.93 | |
| | | | 15% vinyl acetate | |
| Total Thickness | EVOH EF CR | | copolymer | |
| (″) | Layer 1 | | Layer 2 | |
| 0.0016 | Thickness | Perm | Thickness | Perm |
| Total ASTM | 0.0009 | 0.141 | 0.0007 | 4.2 |
| Perms @ mean | | | | |
| 25% RH | | | | |
| 0.2 | | | | |
| Total ASTM | 0.0009 | 14.77 | 0.0007 | 3 |
| Perms @ mean | | | | |
| 75% RH 5 | | | | |

Table 18 presents calculated permeance data for a coextruded EVOH/EVA/Nylon film, based on the individual layer characteristics (Above).

TABLE 18

| | | | ExxonMobil | | | |
|---|---|---|---|---|---|---|
| | | | Escorene | | | |
| | | | Ultra | | | |
| | | | EVA LD719.93 | | | |
| | | | 15% vinyl acetate | | Nylon | |
| Total | EVOH EF CR | | copolymer | | Layer 3 | |
| Thickness (″) | Layer 1 | | Layer 2 | | Thick- | |
| 0.0036 | Thickness | Perm | Thickness | Perm | ness | Perm |
| Total | 0.0009 | 0.141 | 0.0007 | 4.2 | 0.002 | 0.76 |
| ASTM | | | | | | |
| Perms @ | | | | | | |
| mean 25% | | | | | | |
| RH | | | | | | |
| 0.4 | | | | | | |
| Total | 0.0009 | 14.77 | 0.0007 | 3 | 0.002 | 11.90 |
| ASTM | | | | | | |
| Perms @ | | | | | | |
| mean 75% | | | | | | |
| RH 8 | | | | | | |

Table 19 presents calculated permeance data for another coextruded EVOH/EVA film, based on the individual layer characteristics (Above).

TABLE 19

| | | | ExxonMobil Escorene | |
|---|---|---|---|---|
| | | | Ultra EVA LD719.93 | |
| | | | 15% vinyl acetate | |
| Total Thickness | EVOH EF CR | | copolymer | |
| (″) | Layer 1 | | Layer 2 | |
| 0.0012 | Thickness | Perm | Thickness | Perm |
| Total ASTM | 0.00045 | 0.3 | 0.0007 | 4.2 |
| Perms @ mean | | | | |
| 25% RH | | | | |
| 0.7 | | | | |
| Total ASTM | 0.00045 | 30 | 0.0007 | 3 |
| Perms @ mean | | | | |
| 75% RH 5 | | | | |

Table 20 presents calculated permeance data for another coextruded EVOH/EVA/EVOH film, based on the individual layer characteristics (Above).

TABLE 20

| | | | ExxonMobil | | | |
|---|---|---|---|---|---|---|
| | | | Escorene | | | |
| | | | Ultra EVA | | | |
| | | | LD719.93 | | | |
| | | | 15% vinyl acetate | | | |
| Total | EVOH EF CR | | copolymer | | EVOH EF CR | |
| Thickness (″) | Layer 1 | | Layer 2 | | Layer 3 | |
| 0.0016 | Thickness | Perm | Thickness | Perm | Thickness | Perm |
| Total | 0.00045 | 0.3 | 0.0007 | 4.2 | 0.00045 | 0.3 |
| ASTM | | | | | | |
| Perms @ | | | | | | |
| mean 25% RH | | | | | | |
| 0.5 | | | | | | |
| Total | 0.00045 | 30 | 0.0007 | 3 | 0.00045 | 30 |
| ASTM | | | | | | |
| Perms @ | | | | | | |
| mean | | | | | | |
| 75% RH 6 | | | | | | |

Table 21 presents calculated permeance data for a coextruded Nylon/EVA/EVOH film, based on the individual layer characteristics (Above).

TABLE 21

| | | | ExxonMobil | | | |
|---|---|---|---|---|---|---|
| | | | Escorene | | | |
| | | | Ultra EVA | | | |
| | | | LD719.93 | | | |
| | | | 15% vinyl acetate | | | |
| Total | Nylon | | copolymer | | EVOH EF CR | |
| Thickness (″) | Layer 1 | | Layer 2 | | Layer 3 | |
| 0.0032 | Thickness | Perm | Thickness | Perm | Thickness | Perm |
| Total | 0.002 | 0.76 | 0.0007 | 4.2 | 0.00045 | 0.3 |
| ASTM | | | | | | |
| Perms @ | | | | | | |
| mean | | | | | | |
| 25% RH | | | | | | |
| 0.7 | | | | | | |
| Total | 0.002 | 11.90 | 0.0007 | 3 | 0.00045 | 30 |
| ASTM | | | | | | |
| Perms @ | | | | | | |
| mean | | | | | | |
| 75% RH 8 | | | | | | |

Table 22 presents calculated permeance data for another coextruded Nylon/EVA/EVOH film, based on the individual layer characteristics (Above).

TABLE 22

| | | | ExxonMobil | | | |
|---|---|---|---|---|---|---|
| | | | Escorene | | | |
| | | | Ultra EVA | | | |
| | | | LD719.93 | | | |
| | | | 15% vinyl acetate | | | |
| Total | Nylon | | copolymer | | EVOH EF CR | |
| Thickness (″) | Layer 1 | | Layer 2 | | Layer 3 | |
| 0.0022 | Thickness | Perm | Thickness | Perm | Thickness | Perm |
| Total | 0.001 | 1.5 | 0.0007 | 4.2 | 0.00045 | 0.3 |
| ASTM | | | | | | |
| Perms @ | | | | | | |
| mean 25% RH | | | | | | |
| 0.9 | | | | | | |
| Total | 0.001 | 24 | 0.0007 | 3 | 0.00045 | 30 |
| ASTM | | | | | | |
| Perms @ | | | | | | |
| mean 75% | | | | | | |
| RH 7 | | | | | | |

Table 23 presents calculated permeance data for a coextruded EVOH/EVA film, based on the individual layer characteristics (Above).

TABLE 23

| | | | ExxonMobil Escorene | |
|---|---|---|---|---|
| | | | Ultra EVA LD719.93 | |
| | | | 15% vinyl acetate | |
| Total Thickness | EVOH EF CR | | copolymer | |
| (″) | Layer 1 | | Layer 2 | |
| 0.0012 | Thickness | Perm | Thickness | Perm |
| Total ASTM | 0.00045 | 0.3 | 0.0007 | 4.2 |
| Perms @ mean | | | | |
| 25% RH | | | | |
| 0.7 | | | | |
| Total ASTM | 0.00045 | 30 | 0.0007 | 3 |
| Perms @ mean | | | | |
| 75% RH 5 | | | | |

Table 24 presents calculated permeance data for a coextruded EVOH/Nylon/EVOH film, based on the individual layer characteristics (Above).

TABLE 24

| Total | Soarus EVOH 44 | | Nylon | | EVOH EF CR | |
|---|---|---|---|---|---|---|
| Thickness (″) | Layer 1 | | Layer 2 | | Layer 3 | |
| 0.0021 | Thickness | Perm | Thickness | Perm | Thickness | Perm |
| Total ASTM | 0.0006 | 0.13 | 0.001 | 1.5 | 0.00045 | 0.3 |
| Perms @ | | | | | | |
| mean 25% RH | | | | | | |
| 0.3 | | | | | | |
| Total ASTM | 0.0006 | 4.1 | 0.001 | 24 | 0.00045 | 30 |
| Perms @ | | | | | | |
| mean 75% RH | | | | | | |
| 10 | | | | | | |

Table 25 presents calculated permeance data for a coextruded EVOH/EVA/EVOH film, based on the individual layer characteristics (Above).

TABLE 25

| | | | ExxonMobil | | | |
|---|---|---|---|---|---|---|
| | | | Escorene | | | |
| | | | Ultra EVA | | | |
| | | | LD767.MJ | | | |
| | | | 29.5% | | | |
| | | | vinyl acetate | | | |
| Total | EVOH EF CR | | copolymer | | EVOH EF CR | |
| Thickness (″) | Layer 1 | | Layer 2 | | Layer 3 | |
| 0.0018 | Thickness | Perm | Thickness | Perm | Thickness | Perm |
| Total ASTM | 0.00045 | 0.3 | 0.0009 | 9.8 | 0.00045 | 0.3 |
| Perms @ | | | | | | |
| mean 25% RH | | | | | | |
| 0.6 | | | | | | |
| Total ASTM | 0.00045 | 30 | 0.0009 | 7.1 | 0.00045 | 30 |
| Perms @ | | | | | | |
| mean 75% RH | | | | | | |
| 11 | | | | | | |

Table 26 presents calculated permeance data for a coextruded EVOH/PE/EVOH film, based on the individual layer characteristics (Above).

TABLE 26

| | | | Bemis | | | |
|---|---|---|---|---|---|---|
| | | | Clysar LE | | | |
| Total | EVOH EF CR | | Polyethylene | | EVOH EF CR | |
| Thickness (″) | Layer 1 | | Layer 2 | | Layer 3 | |
| 0.0015 | Thickness | Perm | Thickness | Perm | Thickness | Perm |
| Total ASTM | 0.00045 | 0.3 | 0.0006 | 0.81 | 0.00045 | 0.3 |
| Perms @ | | | | | | |
| mean 25% RH | | | | | | |
| 0.4 | | | | | | |
| Total ASTM | 0.00045 | 30 | 0.0006 | 0.57 | 0.00045 | 30 |
| Perms @ | | | | | | |
| mean 75% RH | | | | | | |
| 1.4 | | | | | | |

Table 27 presents calculated permeance data for a coextruded EVOH/EVA/EVOH film, based on the individual layer characteristics (Above).

TABLE 27

| | | | ExxonMobil | | | |
|---|---|---|---|---|---|---|
| | | | Escorene | | | |
| | | | Ultra | | | |
| | | | EVA | | | |
| | | | LD719.93 | | | |
| | | | 15% vinyl acetate | | | |
| Total | EVOH EF CR | | copolymer | | EVOH EF CR | |
| Thickness (″) | Layer 1 | | Layer 2 | | Layer 3 | |
| 0.0016 | Thickness | Perm | Thickness | Perm | Thickness | Perm |
| Total ASTM | 0.00045 | 0.3 | 0.0007 | 4.2 | 0.00045 | 0.3 |
| Perms @ | | | | | | |
| mean 25% RH | | | | | | |
| 0.5 | | | | | | |
| Total ASTM | 0.00045 | 30 | 0.0007 | 3 | 0.00045 | 30 |
| Perms @ | | | | | | |
| mean | | | | | | |
| 75% RH 6 | | | | | | |

Table 28 presents calculated permeance data for a coextruded EVOH/PE/EVOH film, based on the individual layer characteristics (Above).

TABLE 28

| | | | Bemis | | | |
|---|---|---|---|---|---|---|
| | | | Clysar LE | | | |
| Total | EVOH EF CR | | Polyethylene | | EVOH EF CR | |
| Thickness (″) | Layer 1 | | Layer 2 | | Layer 3 | |
| 0.0012 | Thickness | Perm | Thickness | Perm | Thickness | Perm |
| Total ASTM | 0.00045 | 0.3 | 0.0003 | 1.6 | 0.00045 | 0.3 |
| Perms @ | | | | | | |
| mean 25% RH | | | | | | |
| 0.4 | | | | | | |
| Total ASTM | 0.00045 | 30 | 0.0003 | 1.1 | 0.00045 | 30 |
| Perms @ | | | | | | |
| mean | | | | | | |
| 75% RH 4 | | | | | | |

Table 29 presents calculated permeance data for a coextruded PVOH/PE/PVOH film, based on the individual layer characteristics (Above).

TABLE 29

| | | | Bemis | | | |
|---|---|---|---|---|---|---|
| | Bovlon | | Clysar LE | | Bovlon | |
| Total | PVOH | | Polyethylene | | PVOH | |
| Thickness (″) | Layer 1 | | Layer 2 | | Layer 3 | |
| 0.0013 | Thickness | Perm | Thickness | Perm | Thickness | Perm |
| Total ASTM Perms @ | 0.0005 | 0.016 | 0.0003 | 1.6 | 0.0005 | 0.016 |
| mean | | | | | | |
| 25% RH | | | | | | |
| 0.02 | | | | | | |
| Total ASTM Perms @ | 0.0005 | 26 | 0.0003 | 1.1 | 0.0005 | 26 |
| mean | | | | | | |
| 75% RH | | | | | | |
| 4 | | | | | | |

Table 30 presents calculated permeance data for a coextruded PVOH/EVA/PVOH film, based on the individual layer characteristics (Above).

TABLE 30

| | | | ExxonMobil Escorene | | | |
|---|---|---|---|---|---|---|
| | | | Ultra EVA LD719.93 | | | |
| | Bovlon | | 15% vinyl acetate | | Bovlon | |
| | PVOH | | copolymer | | PVOH | |
| Total Thickness (″) | Layer 1 | | Layer 2 | | Layer 3 | |
| 0.0017 | Thickness | Perm | Thickness | Perm | Thickness | Perm |
| Total ASTM Perms | 0.0005 | 0.016 | 0.0007 | 4.2 | 0.0005 | 0.016 |
| @ mean 25% RH | | | | | | |
| 0.03 | | | | | | |
| Total ASTM Perms | 0.0005 | 25.83 | 0.0007 | 3 | 0.0005 | 25.83 |
| @ mean 75% RH | | | | | | |
| 6 | | | | | | |

Table 31 presents calculated permeance data for a coextruded EVOH/PVOH/EVOH film, based on the individual layer characteristics (Above).

TABLE 31

| | EVOH EF CR | | Bovlon PVOH | | EVOH EF CR | |
|---|---|---|---|---|---|---|
| Total Thickness (″) | Layer 1 | | Layer 2 | | Layer 3 | |
| 0.0014 | Thickness | Perm | Thickness | Perm | Thickness | Perm |
| Total ASTM Perms @ mean | 0.00045 | 0.3 | 0.0005 | 0.016 | 0.00045 | 0.3 |
| 25% RH | | | | | | |
| 0.04 | | | | | | |
| Total ASTM Perms @ mean | 0.00045 | 30 | 0.0005 | 25.83 | 0.00045 | 30 |
| 75% RH | | | | | | |
| 28 | | | | | | |

Table 32 presents calculated permeance data for a coextruded PVOH/Nylon/PVOH film, based on the individual layer characteristics (Above).

TABLE 32

| | Bovlon PVOH | | Nylon | | Bovlon PVOH | |
|---|---|---|---|---|---|---|
| Total Thickness (″) | Layer 1 | | Layer 2 | | Layer 3 | |
| 0.0020 | Thickness | Perm | Thickness | Perm | Thickness | Perm |
| Total ASTM Perms @ mean | 0.0005 | 0.016 | 0.001 | 1.5 | 0.0005 | 0.016 |
| 25% RH | | | | | | |
| 0.03 | | | | | | |
| Total ASTM Perms @ mean | 0.0005 | 25.83 | 0.001 | 24 | 0.0005 | 25.83 |
| 75% RH | | | | | | |
| 25 | | | | | | |

Table 33 presents calculated permeance data for a coextruded PVOH/Nylon/EVOH film, based on the individual layer characteristics (Above).

TABLE 33

| | Bovlon PVOH | | Nylon | | Soarus EVOH 44 | |
|---|---|---|---|---|---|---|
| Total Thickness (″) | Layer 1 | | Layer 2 | | Layer 3 | |
| 0.0021 | Thickness | Perm | Thickness | Perm | Thickness | Perm |
| Total ASTM Perms @ mean | 0.0005 | 0.016 | 0.001 | 1.5 | 0.0006 | 0.13 |
| 25% RH | | | | | | |
| 0.06 | | | | | | |
| Total ASTM Perms @ mean | 0.0005 | 25.83 | 0.001 | 24 | 0.0006 | 4.1 |
| 75% RH | | | | | | |
| 10 | | | | | | |

Table 34 presents calculated permeance data for a coextruded EVA/Nylon/EVA film, based on the individual layer characteristics (Above).

TABLE 34

| | ExxonMobil Escorene | | | | ExxonMobil Escorene | |
|---|---|---|---|---|---|---|
| | Ultra EVA LD719.93 | | | | Ultra EVA LD719.93 | |
| | 15% vinyl acetate | | | | 15% vinyl acetate | |
| | copolymer | | Nylon | | copolymer | |
| Total Thickness (″) | Layer 1 | | Layer 2 | | Layer 3 | |
| 0.0048 | Thickness | Perm | Thickness | Perm | Thickness | Perm |
| Total ASTM Perms | 0.0014 | 2.11 | 0.002 | 0.76 | 0.0014 | 2.11 |
| @ mean 25% RH | | | | | | |
| 1.2 | | | | | | |
| Total ASTM Perms | 0.0014 | 1.50 | 0.002 | 11.90 | 0.0014 | 1.50 |
| @ mean 75% RH | | | | | | |
| 2.4 | | | | | | |

Table 35 presents calculated permeance data for a coextruded EVOH/PVOH film, based on the individual layer characteristics (Above).

TABLE 35

| | | |
|---|---|---|
| | EVOH EF CR | Bovlon PVOH |
| Total Thickness (″) | Layer 1 | Layer 2 |

| 0.0010 | Thickness | Perm | Thickness | Perm |
|---|---|---|---|---|
| Total ASTM Perms | 0.00045 | 0.3 | 0.0005 | 0.016 |
| @ mean 25% RH | | | | |
| 0.03 | | | | |
| Total ASTM Perms | 0.00045 | 30 | 0.0005 | 25.83 |
| @ mean 75% RH | | | | |
| 28 | | | | |

Table 36 presents calculated permeance data for a coextruded EVOH/Polypropylene/EVOH film, based on the individual layer characteristics (Above).

TABLE 36

| | EVOH | | Profol | | EVOH | |
|---|---|---|---|---|---|---|
| Total | EF CR | | Polypropylene | | EF CR | |
| Thickness (″) | Layer 1 | | Layer 2 | | Layer 3 | |
| 0.0016 | Thickness | Perm | Thickness | Perm | Thickness | Perm |
| Total ASTM Perms @ mean | 0.00045 | 0.3 | 0.00065 | 0.3 | 0.00045 | 0.3 |
| 25% RH | | | | | | |
| 0.3 | | | | | | |
| Total ASTM Perms @ mean | 0.00045 | 30 | 0.00065 | 0.4 | 0.00045 | 30 |
| 75% RH | | | | | | |
| 1 | | | | | | |

Table 37 presents calculated permeance data for a laminated EVOH/Polyester/EVOH film, based on the individual layer characteristics (Above).

TABLE 37

| | EVOH EF CR | | SKC Polyester | | EVOH EF CR | |
|---|---|---|---|---|---|---|
| Total Thickness (″) | Layer 1 | | Layer 2 | | Layer 3 | |
| 0.0016 | Thickness | Perm | Thickness | Perm | Thickness | Perm |
| Total ASTM Perms @ mean | 0.00045 | 0.3 | 0.0007 | 0.8 | 0.00045 | 0.3 |
| 25% RH | | | | | | |
| 0.4 | | | | | | |
| Total ASTM Perms @ mean | 0.00045 | 30 | 0.0007 | 0.7 | 0.00045 | 30 |
| 75% RH | | | | | | |
| 2 | | | | | | |

Table 38 presents calculated permeance data for a laminated EVOH/Polycarbonate/EVOH film, based on the individual layer characteristics (Above).

TABLE 38

| | | | GE Lexan | | | |
|---|---|---|---|---|---|---|
| | EVOH EF CR | | Polycarbonate | | EVOH EF CR | |
| Total Thickness (″) | Layer 1 | | Layer 2 | | Layer 3 | |
| 0.0025 | Thickness | Perm | Thickness | Perm | Thickness | Perm |
| Total ASTM Perms @ mean | 0.00045 | 0.3 | 0.0016 | 2.5 | 0.00045 | 0.3 |
| 25% RH | | | | | | |
| 0.7 | | | | | | |
| Total ASTM Perms @ mean | 0.00045 | 0.3 | 0.0016 | 2 | 0.00045 | 30 |
| 75% RH | | | | | | |
| 3 | | | | | | |

Table 39 presents calculated permeance data for a laminated EVOH/PVC film, based on the individual layer characteristics (Above).

TABLE 39

| | | |
|---|---|---|
| | EVOH EF CR | Grafix PVC |
| Total Thickness (″) | Layer 1 | Layer 2 |

| 0.0023 | Thickness | Perm | Thickness | Perm |
|---|---|---|---|---|
| Total ASTM Perms | 0.0009 | 0.1 | 0.0014 | 0.8 |
| @ mean 25% RH | | | | |
| 0.3 | | | | |
| Total ASTM Perms | 0.0009 | 15 | 0.0014 | 0.6 |
| @ mean 75% RH 1 | | | | |

Table 40 presents calculated permeance data for a laminated EVOH/Polyurethane film, based on the individual layer characteristics (Above).

TABLE 40

| | | |
|---|---|---|
| | | Deerfield |
| | | Urethane |
| | EVOH EF CR | PT9200-US |
| Total Thickness (″) | Layer 1 | Layer 2 |

| 0.0018 | Thickness | Perm | Thickness | Perm |
|---|---|---|---|---|
| Total ASTM Perms | 0.0009 | 0.141 | 0.00093 | 18.89 |
| @ mean 25% RH | | | | |
| 0.3 | | | | |
| Total ASTM Perms | 0.0009 | 14.77 | 0.00093 | 25.12 |
| @ mean 75% RH | | | | |
| 19 | | | | |

Table 41 presents calculated permeance data for a laminated EVOH/EVA/Polypropylene film, based on the individual layer characteristics (Above).

TABLE 41

| | | | ExxonMobil | | | |
|---|---|---|---|---|---|---|
| | | | Escorene Ultra | | | |
| | | | EVA LD719.93 | | | |
| | | | 15% vinyl | | | |
| | | | acetate | | Profol | |
| Total | EVOH EF CR | | copolymer | | Polypropylene | |
| Thickness (″) | Layer 1 | | Layer 2 | | Layer 3 | |
| 0.0018 | Thickness | Perm | Thickness | Perm | Thickness | Perm |
| Total ASTM | 0.00045 | 0.3 | 0.0007 | 4.2 | 0.00065 | 0.3 |
| Perms @ | | | | | | |
| mean 25% | | | | | | |
| RH | | | | | | |
| 0.5 | | | | | | |
| Total ASTM | 0.00045 | 30 | 0.0007 | 3 | 0.00065 | 0.4 |
| Perms @ | | | | | | |
| mean 75% | | | | | | |
| RH | | | | | | |
| 1 | | | | | | |

Table 42 presents a summary of measured and calculated permeances for the adaptive vapor retarders included in the previous tables.

TABLE 42

| | | ASTM | ASTM | | | | | |
|---|---|---|---|---|---|---|---|---|
| | | E96 | E96 | | | | | |
| Measured | | Perm @ | Perm @ | | | | | |
| or | Table | mean | mean | Thickness | No. of | | | |
| Calculated | No. | 25% RH | 75% RH | (inches) | Layers | Layer 1 | Layer 2 | Layer 3 |
| Measured | 1 & 2 | 0.109 | 0.95 | 0.0012 | 1 | EVOH | | |
| Measured | 1 & 2 | 0.141 | 14.77 | 0.0009 | 1 | EVOH | | |
| Measured | 1 & 2 | 0.035 | 11.88 | 0.0012 | 1 | EVOH | | |
| Measured | 1 & 2 | 0.066 | 2.03 | 0.0012 | 1 | EVOH | | |
| Measured | 1 & 2 | 0.11 | 5.09 | 0.001 | 1 | Nylon* | EVOH* | Nylon* |
| Measured | 1 & 2 | 0.38 | 3.88 | 0.00065 | 1 | Nylon* | EVOH* | Nylon* |
| Measured | 1 & 2 | 0.76 | 11.90 | 0.002 | 1 | Nylon | | |
| Measured | 1 & 2 | 1.10 | 7.92 | 0.001 | 1 | Nylon | | |
| Measured | 1 & 2 | 1.64 | 11.94 | 0.0006 | 1 | Nylon | | |
| Measured | 1 & 2 | 0.016 | 25.83 | 0.0005 | 1 | PVOH | | |
| Calculated | 4 | 0.02 | 5.9 | 0.0024 | 1 | EVOH | | |
| Calculated | 5 | 0.07 | 24 | 0.0006 | 1 | EVOH | | |
| Calculated | 5 | 0.13 | 4.1 | 0.0006 | 1 | EVOH | | |
| Calculated | 6 | 0.2 | 2 | 0.0006 | 1 | EVOH | | |
| Calculated | 7 | 0.3 | 30 | 0.00045 | 1 | EVOH | | |
| Calculated | 8 | 1.5 | 2 | 0.001 | 1 | Nylon | | |
| Calculated | 16 | 0.3 | 9 | 0.0035 | 3 | EVOH | Nylon | EVOH |
| Calculated | 17 | 0.2 | 5 | 0.0016 | 2 | EVOH | EVA | |
| Calculated | 18 | 0.4 | 8 | 0.0036 | 3 | EVOH | EVA | Nylon |
| Calculated | 19 | 0.7 | 5 | 0.0012 | 2 | EVOH | EVA | |
| Calculated | 20 | 0.5 | 6 | 0.0016 | 3 | EVOH | EVA | EVOH |
| Calculated | 21 | 0.7 | 8 | 0.0032 | 3 | Nylon | EVA | EVOH |
| Calculated | 22 | 0.9 | 7 | 0.0022 | 3 | Nylon | EVA | EVOH |
| Calculated | 23 | 0.7 | 5 | 0.0012 | 2 | EVOH | EVA | |
| Calculated | 24 | 0.3 | 10 | 0.0021 | 3 | EVOH | Nylon | EVOH |
| Calculated | 25 | 0.6 | 11 | 0.0018 | 3 | EVOH | EVA | EVOH |
| Calculated | 26 | 0.4 | 1.4 | 0.0015 | 3 | EVOH | PE | EVOH |
| Calculated | 27 | 0.5 | 6 | 0.0016 | 3 | EVOH | EVA | EVOH |
| Calculated | 28 | 0.4 | 4 | 0.0012 | 3 | EVOH | PE | EVOH |
| Calculated | 29 | 0.02 | 4 | 0.0013 | 3 | PVOH | PE | PVOH |
| Calculated | 30 | 0.03 | 6 | 0.0017 | 3 | PVOH | EVA | PVOH |
| Calculated | 31 | 0.04 | 28 | 0.0014 | 3 | EVOH | PVOH | EVOH |
| Calculated | 32 | 0.03 | 25 | 0.002 | 3 | PVOH | Nylon | PVOH |
| Calculated | 33 | 0.06 | 10 | 0.0021 | 3 | PVOH | Nylon | EVOH |
| Calculated | 34 | 1.2 | 2.4 | 0.0048 | 3 | EVA | Nylon | EVA |
| Calculated | 35 | 0.03 | 28 | 0.001 | 2 | EVOH | PVOH | |
| Calculated | 36 | 0.3 | 1 | 0.0016 | 3 | EVOH | Polypropylene | EVOH |
| Calculated | 37 | 0.4 | 2 | 0.0016 | 3 | EVOH | Polyester | EVOH |
| Calculated | 38 | 0.7 | 3 | 0.0025 | 3 | EVOH | Polycarbonate | EVOH |
| Calculated | 39 | 0.3 | 1 | 0.0023 | 2 | EVOH | PVC | |
| Calculated | 40 | 0.3 | 19 | 0.0018 | 2 | EVOH | Polyurethane | |
| Calculated | 41 | 0.5 | 1 | 0.0018 | 3 | EVOH | EVA | Polypropylene |

*The “OXYSHIELD ™” films are believed to be a three layer construction with Nylon outer layers and an EVOH core.

In still other embodiments, the film composition may include a blend of two or more polymers. Two examples are EVOH blended with polyethylene and EVOH blended with Nylon or Polyamide. The percentage of EVOH in a Nylon/EVOH blend may be from about 10% to about 80% (with a preferred range of about 25% to about 75%). The percentage of EVOH in a PE/EVOH blend may be from about 10% to about 30%.

Some embodiments include blends comprising about 30% EVOH with another polymer. For example, the remaining 70% of the blended polymer may be primarily low density polyethylene. Alternatively, the remaining 70% may be another polymer, or a combination of two or more other polymers.

In some embodiments, a blend may be made by recycling multiple layer films that include EVOH or PVOH. These may include a plurality of separate (single-material) films, coextruded films, laminated films or combinations thereof, wherein at least one layer of at least one film comprises EVOH or PVOH.

Although FIG. 1A shows the film being applied to the bottom surface of the building material, in other embodiments, the film is applied to the top surface.

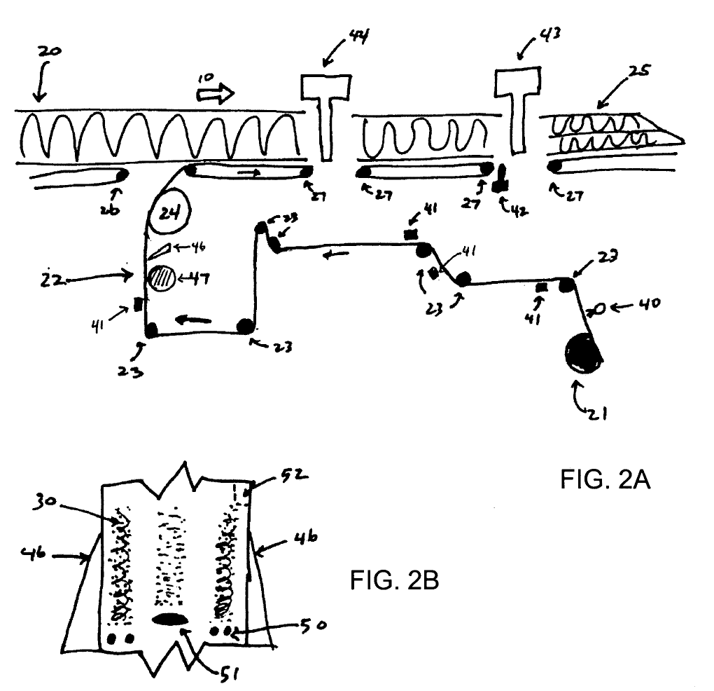

Referring to FIG. 2A, a building material 20 is fed through the process by a conveyor 26 in a predetermined linear path 10. The water vapor retarder film is provided on a roll 21 and also fed into the adhesion process via rollers 23. The building material and the laminated article can be moved along the production path via a series of optional conveyers 27. The adhesive is applied by a sprayer 22 and the water vapor retarder film partially coated with adhesive is joined with the building material to form a laminated article 25. In one embodiment, the spraying device, e.g., nozzles, are in a horizontal line relative to the film. As above, the roller 24 can be heated to provide additional adhesive strength. In another embodiment depicted in FIG. 2A, a bowed roller 47 for removing or preventing wrinkles in the film can be included in the area of the process where the adhesive is applied to the film. In a preferred embodiment, the bowed roller is above the area where the adhesive is applied.

In another embodiment, at least one static neutralizing bar 41 and/or static neutralizing device 42 can be provided to reduce static on the vapor retarder film and/or the laminated article.

In another embodiment, a cutting device 44 such as a chopper can be included when the building material is an insulation roll or batt. In addition, a folding device 43 can also be included such as a batt folder when the building material is an insulation batt. In one aspect of this embodiment, the laminated article 25 is a folded laminated article.

In some embodiments, the film is provided with a printed pattern which can be provided on the roll 21 or be applied during the manufacturing process via a printing device 40 such as an ink-jet print head.

In some embodiments, stapling tabs 52 (FIG. 2B) may be provided via tab formation bars 46.

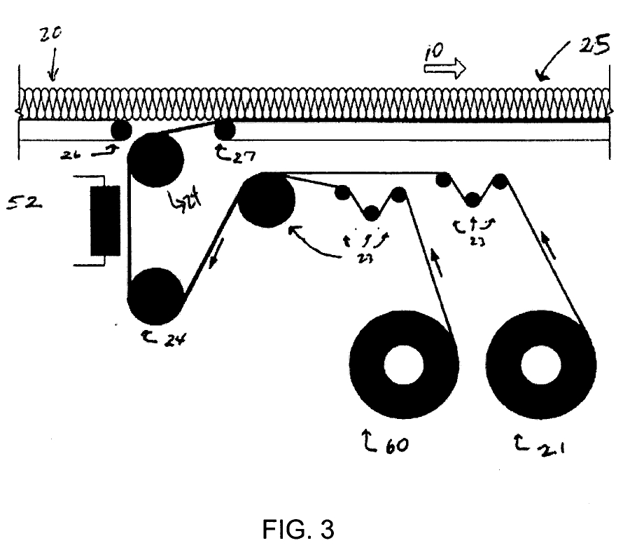

Referring to FIG. 3, an alternative process for laminating the water vapor retarder film component to the building material is depicted whereby the water vapor retarder film is provided on a roll 21 and a roll 60 of a non-woven veil of thermoplastic fibers is also provided. The thermoplastic nonwoven with a melting temperature lower than the water vapor retarder film acts as an adhesive to bond the water vapor retarder film to the insulation. The water vapor retarder film and the non-woven veil are fed through the process via tension rollers 23. After the non-woven veil and the water vapor retarder film have contacted, they may be heated via roller(s) 24 and/or heated via heating element 52 (such as an infrared heater) to melt the thermoplastic veil which adheres the film to the building material 20 thereby forming a laminated article 25.

A roll coater may be used to apply the adhesive to the adaptive vapor film. The adhesive may be applied in a pattern such as stripes, sinusoids, or the like. In some embodiments, a plurality of strips (e.g., formed from a plastic film such as polyester or a metal such as aluminum) positioned between the application roller and the adaptive vapor barrier film cause the adhesive to be applied to the film in a plurality of stripes that covers less than about one half of the surface area of the film.

The building material onto which the water vapor retarder film component is adhered during the manufacture of the laminated article can be any commonly used building material used. Preferably, however, the building material has a water vapor diffusion resistance which is less than the water vapor diffusion resistance of the water vapor retarder film component.

Non-limiting examples of suitable building materials that can be employed in the exemplary manufacturing process include paper, perforated polymer films, polymer films with an ASTM E96 procedure A and B water vapor permeance greater than 25, particle board, chip board, oriented strand board, plywood paneling, gypsum board (standard or fiber reinforced), fiber board, cement board, cementitious wood wool board, calcium silica board, fiber insulation batts or slabs, foam insulation slabs, wall paper, carpet, and plastic netting. These building materials may be used with any of the exemplary adaptive vapor retarder films including EVOH, PVOH, nylon or coextrusions, or laminations, or blends containing EVOH, PVOH, or nylon. Additional examples, such as woven fabrics and non-woven felts, are suitable building materials suitable for exemplary adaptive vapor retarder films including EVOH, nylon, PVOH, or coextrusions, or laminations, or blends containing EVOH, PVOH or nylon. The building material may also be a woven or non-woven film. Woven polypropylene is an example of a suitable woven film. Claf is an example of a suitable nonwoven film—cross laminated polyethylene open mesh nonwoven fabric #SS1601 and #HS9342 UV resistant manufactured by Atlanta Nisseki CLAF Inc. of Kennesaw, Ga.).

The water vapor retarder film is adhered to at least one surface of the building material. For example, the water vapor retarder film is adhered to at least one major or minor surface of the building material, preferably at least one major surface. As used herein, “major surface” refers to the surface or surfaces of the material which have a larger surface area than a second surface, and likewise a “minor surface” has a smaller surface area than another surface of the material. In a preferred embodiment, at least one surface of the building material is not adhered to the water vapor retarder film component. In an alternative embodiment, the water vapor retarder film can sandwich the building material component such that a film is adhered to two opposite sides, major or minor, of the building material. The film can also be sandwiched between two layers of building material.

The adhesives may include (but are not limited to) Henkel 80-8273 and “Sanicare®” HM-6700US thermoplastic hot melt adhesives; and 50-0965 MHV and 57-3027TT water base adhesives from Henkel Corp., Elgin, Ill.; Thermoplastic Hot Melt, “CoolMelt”™ and “SprayPac”™ 0452 from Loctite of Rocky Hill, Conn. Some thermoplastic adhesives such as Henkel “Sanicare®” HM-6700US are formulated to be applied at low temperatures compatible with lower melting polymer film substrates such as polyethylene.

Alternatively, any polyolefin based adhesive may be used provided it adheres the water vapor retarder film to the building material and permits the water vapor retarder film to maintain at least a part of its water vapor transmission properties as described herein. Preferably, the adhesive has a lower melting point than the film onto which the adhesive is applied to prevent the film from melting prior to its adhesion to the building material. For example, a polypropylene-based or polyethylene-based adhesive may be used. One example of such an adhesive is Henkel adhesive #80-8273 (Henkel Adhesives Elgin, Ill.).

In one embodiment of providing the adhesive, the adhesive can be applied as a hot-melt which is sprayed onto the water vapor retarder film, e.g., using elliptical and swirl spray devices. In another embodiment, the adhesive can be provided as a non-woven thermoplastic veil which can also subsequently heated in a similar manner. In another embodiment, the adhesive may be a water-based adhesive that is applied with a roll coater to the vapor retarder film. The adhesive may be applied in stripes to permit much of the film to be uncoated by the adhesive.

The adhesive can be applied to the water vapor retarder film, so that the permeance properties of the film component are not occluded or prevented from functioning properly. While there may be some reduction of the permeance, it is preferred that the film retains at least about 50% of the water-vapor transmission properties relative to the film prior to the adhesive being provided. In alternative embodiments, the permeance of the film with adhesive retains at least about 60%, 70%, 80%, 90%, 95%, 97% and 99%, inclusive of all values and ranges there between.

The two-fold requirement of adhering the water vapor retarder film to the insulation and maintaining at least a part of the water-vapor transmission properties of the film can be accomplished by providing the adhesive in an amount of about 0.4 to about 1.5 g per lineal foot of the film based on a 15 inch film width. Further, the adhesive can be provided in an amount of about 0.5 to about 1.4 grams per lineal foot, inclusive of 0.6, 0.7, 0.8, 0.9, 1.0, 1.1, 1.2, and 1.3 grams per lineal foot again based on a 15 inch film width.

The adhesive, when sprayed onto the water vapor retarder film, can be provided substantially uniformly onto the film provided the above permeance and/or application criteria are maintained. In an alternative embodiment, the adhesive can be provided as shown in the embodiments in FIGS. 1B and 2B. In these embodiments, the adhesive 30 is applied to the film at the edges in a swirl pattern such that, at the center of the film, the adhesive 30 is applied in an elliptical pattern. FIG. 2B shows the swirl pattern 30 is applied with a swirl gun 50 and the elliptical pattern is applied with an elliptical spray gun 51. Examples of suitable spray guns include those hot melt spray guns sold by Nordson Corporation of Westlake, Ohio.

In some embodiments, a suitable non-woven veil may be a low-melting point veil composed of thermoplastic fibers. Suitable fibers include polypropylene, polyethylene and mixtures thereof. The fibers may be virgin or recycled. Once again, the application of the veil to the film component is provided such that the permeance and/or application criteria discussed above are maintained. Examples of suitable non-wovens for this purpose include, but are not limited to Spunfab POF 4913 polyolefin nonwoven, activation temperature 172° F. and Spunfab PA 1541 polyamide activation temperature 189° F., both 1.1 grams/sq.ft.

During the manufacturing process or subsequent to the process, the laminated article can be cut into predetermined dimensions that would be preferable for storage, transport, sale, and end use (e.g., installation). If performed during the process, the cutting should preferably be after the film has adhered to the building material component. Further, it is also possible that certain building materials such as fiber insulation can be folded during or after the manufacturing process and would be preferably employed after the film has adhered to the building material component.

The laminated article can also be treated to reduce the static electricity, for example, by incorporating anti-static devices and/or anti-static treatments such as those commonly used in the art, or future developed anti-static devices/treatments.

In one embodiment, where the laminated article comprises an insulation batt or slab adhered to the film, the laminated article is packaged. Commonly, when insulation batts or slabs are packaged they are compressed. In this situation, the laminated article may be pushed through a snout, which is optionally coated with, for example, tetrafluoroethylene (TFE), into a plastic bag.

An exemplary laminated article comprises at least one film component as described herein and at least one building material component with an adhesive between the at least one film component and the at least one building material where the adhesive is present in an amount of about 0.4 to about 1.5 g per lineal foot of the film based on a 15 inch film width. In further embodiments, the adhesive is present in an amount of about 0.5 to about 1.4 grams per lineal foot, inclusive of 0.6, 0.7, 0.8, 0.9, 1.0, 1.1, 1.2, and 1.3 grams per lineal foot again based on a 15 inch film width.

In an alternative embodiment, the laminated article includes at least one film component as described herein and at least one building material component with an adhesive between the at least one film component and the at least one building material where the adhesive is present in an amount such that at least 50% of the humidity adaptive properties relative to the film prior to the adhesive being provided.

In alternative embodiments, the permeance of the film with adhesive retains at least about 60%, 70%, 80%, 90%, 95%, 97% and 99%, inclusive of all values and ranges therebetween. The adhesive used for the laminated article and the application thereof can also be chosen such that the adhesive is applied at the correct application which yields a laminated article having an ASTM E 84 maximum flame spread/smoke developed rating of 25/50 as determined by ASTM E 84 “Standard Test Method for Surface Burning Characteristics of Building Materials.” The adhesive used for the laminated article and the application thereof can also be chosen such that the laminated article achieves no fungal growth when tested by ASTM C1338 “Standard Test Method for Determining Fungi Resistance of Insulation Materials and Facings” and ASTM G21 “Standard Practice for Determining Resistance of Synthetic Polymeric Materials to Fungi.”

Variations and other embodiments for the laminated article can be drawn from the description of the process provided above.

The laminated article described herein can be used to provide a vapor retarder to a building or portion of a building, e.g., a wall, roof or floor, or in any construction scenario where building materials, such as insulation are commonly employed. For example, the laminated article can be used, in addition to buildings, in transportation or moving vehicles, such as automobiles, planes, and trains, and particularly those designed for refrigeration. In addition, appliances such as refrigerators and/or freezers may also benefit from the use of the laminated article described herein. As used herein, “building” includes both commercial and residential buildings, such as office buildings, stores, houses and mobile homes. Thus, the laminated article can be employed during the construction of a new building or renovation of an existing building. The laminated article would be provided to the appropriate location, e.g., between at least two studs of a wall or at least two rafters of a roof during the appropriate stage of the project. In a further embodiment, building components are commonly fabricated distant from the location of the actual location of the building (e.g., pre-fabricated building panels) and therefore, the laminated article can be employed during the manufacturing of those pre-fabricated building components and include, for example, a pre-fabricated wall, roof, or floor component.

### EXAMPLES

### Example 1

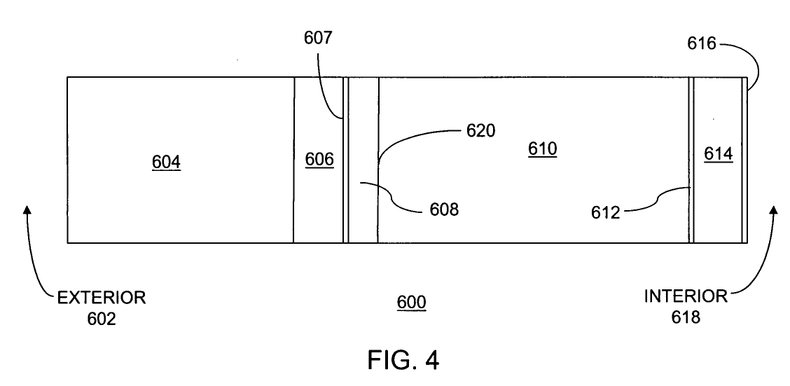

FIG. 4 shows a first configuration of a brick facade building wall structure 600, including the exterior ambient environment 602, brick 604, an air space 606, building paper 607 a 0.625 inch Oriented Strand Board (OSB) sheathing 608, a 3½″ thick fiber glass insulation batt 610 in a cavity, a vapor retarder layer 612, dry wall 614, latex paint 616, and the interior environment 618. Although the exemplary configuration is shown with a very short height, the exemplary structure can extend from the bottom to the top of an exterior wall. The adhesive laminating the vapor retarder layer 612 to the blanket or batt 610 is not shown in FIG. 4, but is understood to be present.

The transient heat and moisture simulation program employed was WUFI 3.3Pro., 2000, by Hartwig Kunzel, Achilles Karagiozis, and Andreas Holm. The WUFI ORNL/IBP model is a transient heat and mass transfer model that can be used to assess the heat and moisture distributions for a wide range of building material classes and climatic conditions found in North America and around the World. Table 43 lists the materials and permeance values used in the simulations.

TABLE 43

| | | Permeance |
|---|---|---|
| Material | | (US Perms) |
| Polyamide | ASTM E96 Method A | 0.76 |
| | (Dry Cup) 25% mean RH | |
| | Method B (Wet Cup) | 7.8 |
| | 75% mean RH | |
| EVOH/Polypropylene/EVOH | Method A (Dry Cup) | 0.3 |
| | 25% mean RH | |
| | Method B (Wet Cup) | 1 |
| | 75% mean RH | |
| EVOH/Polyester/EVOH | Method A (Dry Cup) | 0.4 |
| | 25% mean RH | |
| | Method B (Wet Cup) | 2 |
| | 75% mean RH | |
| EVOH/PVOH | Method A (Dry Cup) | 0.03 |
| | 25% mean RH | |
| | Method B (Wet Cup) | 28 |
| | 75% mean RH | |

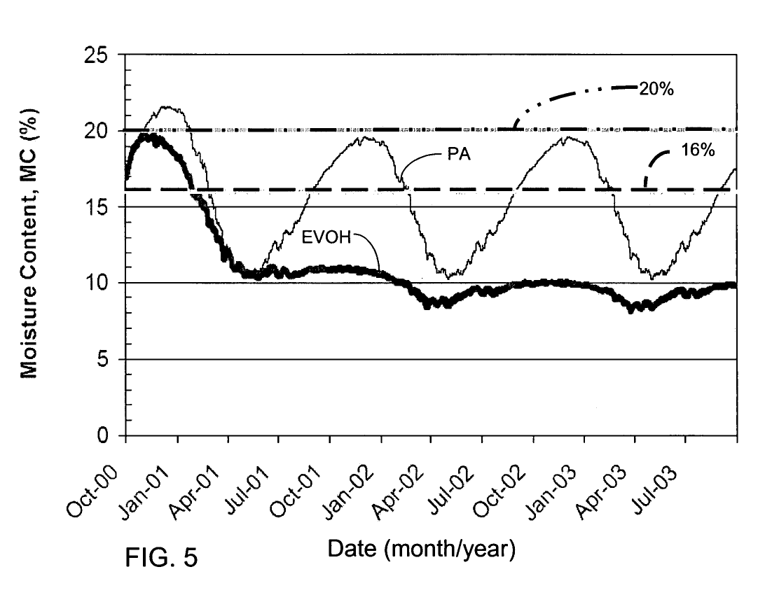

FIG. 5 shows the results of a simulation for the structure of FIG. 4, based on weather in Winnipeg, Canada, for a vertical, south-facing wall. The initial conditions are set to 80% relative humidity moisture content. The interior environment was modeled as having a cyclic high of 75% relative humidity. A three year period beginning Oct. 1, 2000 is simulated. FIG. 5 compares results for the structure of FIG. 4, wherein the vapor retarder 612 is a 0.002″ thick polyamide vapor retarder film) to the results for another structure as shown in FIG. 4, wherein the vapor retarder 612 is an EVOH/polypropylene/EVOH coextrusion (as described in table 36) with a calculated permeance of 0.3 Perm Dry Cup at 25% mean RH, 1 Perm Wet Cup at 75% mean RH, 1.5 Perm at 90% RH. The permeance of the EVOH/Polypropylene/EVOH film (table 36) at 90% RH were estimated using the 25% and 75% mean RH perm calculations and the shape of the water vapor transmission versus % RH curve at 25° C. curve for Eval EVOH EF-F-15 with 32 mole % ethylene in the publication entitled “Permeation of Oxygen and Water Through EVOH Films as Influenced by Relative Humidity” by Zhonbin Zhang, Ian J. Britt, and Marvin A. Tung, in the Journal of Applied Polymer Science, Vol. 82, 2001, pages 1866-1872. On the graph of Moisture Content versus Date in FIG. 5, the dashed line represents 16% moisture content in the OSB sheathing—the established point where mold can grow and bio-degradation can begin to reduce the structural properties of a wood based material. The dash-dotted line represents a 20% moisture content in the OSB sheathing where damage can be assumed to have taken place in wood based materials, necessitating their replacement. A moisture Monitor Position 620 is at the interface of the OSB sheathing 608 and the fiberglass batt 610. The plotted curves in FIG. 5 are from simulated data from the moisture monitor at position 620. Both vapor retarder systems result in elevated OSB and cavity moisture contents during the first winter. This is from the “initial moisture content” loading assumed at the beginning of the simulation. The initial moisture would be the result of green lumber, poured concrete, drywall compound drying, paint drying, exposure to rain and snow during the construction process, and the like.

As shown in FIG. 5, by the second year, the OSB in the structure in which the adaptive vapor retarder barrier 612 is made of EVOH/polypropylene/EVOH (table 36) has an average moisture content of about 9% and a maximum content of about 11%. The OSB in the structure in which the adaptive vapor retarder barrier 612 is made of polyamide has an average moisture content of about 15% and a maximum content of about 19.5%. FIG. 5 shows how the higher water vapor resistance of the EVOH coextruded or laminated material gives it a superior performance to the polyamide film in this construction.

### Example 2

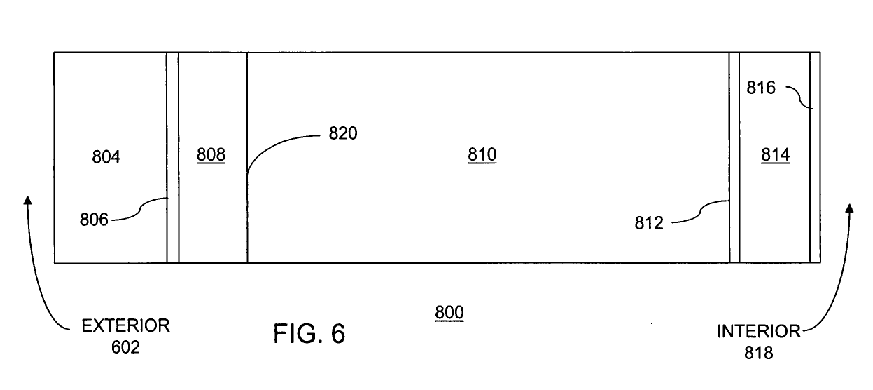

FIG. 6 shows another exemplary configuration including, from left to right, an exterior ambient environment 802, a stucco finish 804, a “TYVEK®” spun bonded polyolefin air barrier house wrap 806 (sold by DuPont Corporation of Wilmington, Del.), an exterior sheathing 808, a 3½″ thick fiber glass batt 810, an adaptive vapor retarder film 812, an interior gypsum wallboard 814, an interior coating such as latex paint 816, and the building interior environment 818. A moisture Monitor Position 820 is at the interface of the sheathing 808 and the fiberglass batt 810. These constructions are typical for low-rise commercial projects. Although the exemplary configuration is shown with a very short height, the exemplary structure can extend from the bottom to the top of an exterior wall. The adhesive laminating the vapor retarder layer 812 to the blanket or batt 810 is not shown in FIG. 6, but is understood to be present.

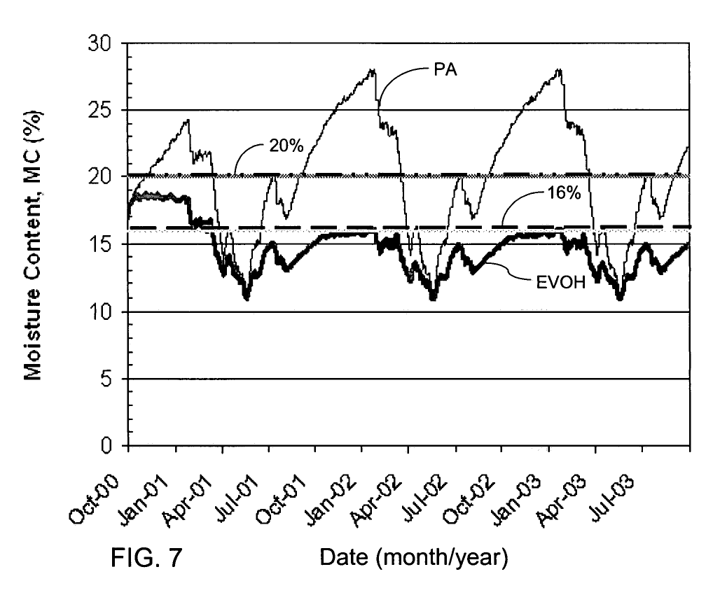

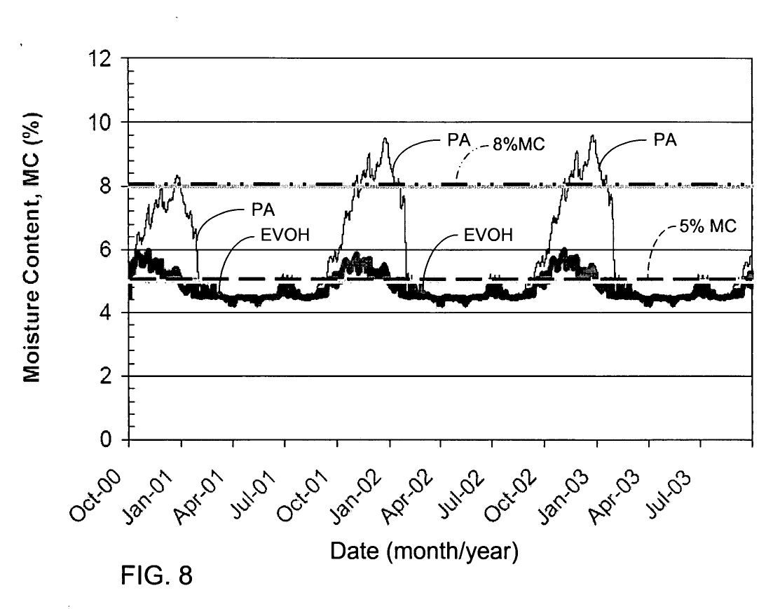

Simulations were run using the structure of FIG. 6. FIGS. 7 and 8 compare two EVOH coextruded or laminated materials, the first (FIG. 7), an EVOH/polypropylene/EVOH coextrusion or laminate as described in table 36, with a calculated permeance of 0.3-US Perms at 25% mean RH, 1 US Perms at 75% mean RH, 1.5 US Perms at mean 90% RH and the second (FIG. 8), an EVOH/polyester/EVOH laminate as described in table 37, with a calculated permeance of 0.4 US Perms at 25% mean RH, 2 US Perms at 75% mean RH, and 3 US Perms at 90% mean RH, to the 0.002″ thick polyamide vapor retarder film. In the simulation of FIG. 7, the exterior sheathing 808 was OSB and the vapor retarder was EVOH/polypropylene/EVOH. In the simulation of FIG. 8, the exterior sheathing 808 was a 0.625 inch thick “DENSGLASS GOLD®” exterior gypsum sheathing (sold by Georgia Pacific Co. of Atlanta, Ga.), and the vapor retarder was EVOH/polyester/EVOH. The permeances of the EVOH/polyester/EVOH film (table 37) and the EVOH/polypropylene/EVOH (table 36) at 90% RH were estimated using the 25% and 75% mean RH perm calculations and the shape of the water vapor transmission versus % RH curve at 25° C. curve for Eval EVOH EF-F-15 with 32 mole % ethylene in the publication entitled “Permeation of Oxygen and Water Through EVOH Films as Influenced by Relative Humidity” by Zhonbin Zhang, Ian J. Britt, and Marvin A. Tung, in the Journal of Applied Polymer Science, Vol. 82, 2001, pages 1866-1872. The models were run based on data for a south-facing wall exposed to Minneapolis, Minn. weather. In the simulation of FIG. 7, the interior relative humidity had a cyclic high of 75%. In the simulation of FIG. 8, the interior relative humidity had a cyclic high of 60%. In both simulations, the initial condition was set to an 80% relative humidity moisture content. The plotted curves in FIGS. 7 and 8 are from simulated data from the moisture monitor at position 820. On the graph of Moisture Content versus Date in FIG. 8, the dot-dashed line represents 8% moisture content in the gypsum sheathing—the point where gypsum boards begin to soften—and the dashed line represents 5%—the normal moisture content for gypsum boards.

Each simulation covered three years of simulation time. The material of the adaptive vapor retarder film 812 was varied between simulation runs. Three adaptive vapor barrier materials were simulated: a 0.002″ thick polyamide vapor film in both FIGS. 7 and 8, an EVOH/polypropylene/EVOH (table 36) film in FIG. 7 having a calculated permeance of about 0.3 Perm at 25% mean RH, 1 Perm at 75% mean RH), and about 1.5 Perms at 90% mean RH, and an EVOH/polyester/EVOH film (as described in table 37) in FIG. 8 having a calculated permeance of about 0.4 Perm at 25% mean RH, and about 2 Perms at 75% mean RH, and about 3 Perms at 90% RH.

The critical moisture contents for gypsum based sheathings are lower than those for wood based materials. As a result, the graph indicators for FIG. 8 are set at 5%, the “normal” moisture content for gypsum boards (a minimum of 3% is required to maintain the gypsum crystalline structure), and 8% where the boards begin to turn soft. Some minimum moisture in needed to maintain the product properties. In FIG. 7 in the second and third years, the moisture content of the OSB with the polyamide vapor retarder reaches a maximum of about 28% and averages about 19%. In FIG. 7 in the second and third years after an approximate 18% moisture content in the first winter, the moisture content of the OSB with the EVOH/polypropylene/EVOH vapor retarder falls to a maximum of about 16% and an average of about 14%. The EVOH/polypropylene/EVOH vapor retarder maintains the OSB sheathing's moisture content below the 20% level where damage can be assumed to have taken place to wood based materials, necessitating their replacement. In FIG. 8 in the second and third years, the moisture content of the gypsum sheathing with the polyamide vapor retarder reaches a maximum of about 9.5%, above the 8% moisture level where gypsum boards begin to soften. In FIG. 8, the moisture content of the gypsum sheathing with the EVOH/polyester/EVOH vapor retarder never reaches the 8% softening level and is maintained at an average of about 5%. FIGS. 7 and 8 show how the higher water vapor resistance of these two EVOH coextruded or laminated materials give them superior performance to the polyamide film in these constructions. These figures are merely three examples of three different films. Other humidity adaptive films may be manufactured that are particularly suited for other geographical regions and climates by varying the films' composition using EVOH, EVA, Nylon, Polyethylene, Polypropylene, Polyester, Polycarbonate, Polyurethane, PVC, and/or polyvinyl alcohol (PVOH).

### Example 3

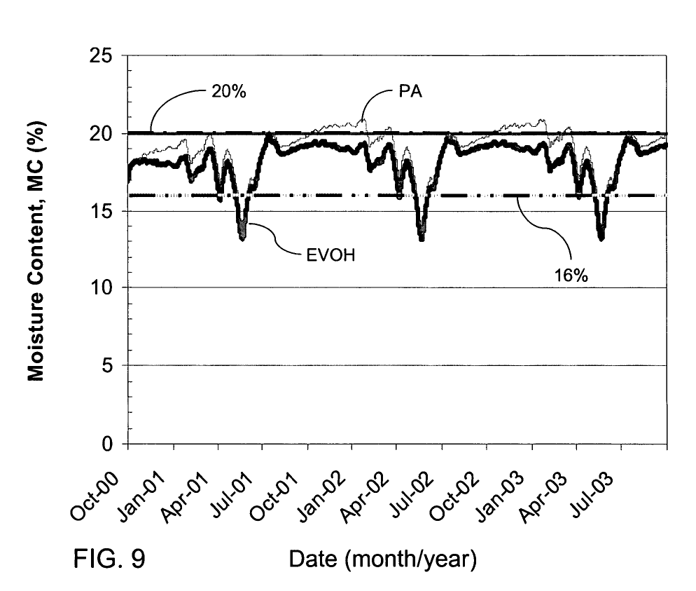

FIG. 9 shows simulation results for a configuration as shown in FIG. 4, wherein the smart vapor retarder 612 is an EVOH/PVOH/coextruded or laminated adaptive vapor retarder film (as described in table 35) with calculated 0.03 US Perm at 25% mean RH, 28 US Perms at 75% mean RH, 40 US Perms at 90% mean RH (as described in Table 35). The permeance of the EVOH/PVOH film (table 35) at 90% RH were estimated using the 25% and 75% mean RH perm calculations and the shape of the water vapor transmission versus % RH curve at 25° C. curve for Eval EVOH EF-F-15 with 32 mole % ethylene in the publication entitled “Permeation of Oxygen and Water Through EVOH Films as Influenced by Relative Humidity” by Zhonbin Zhang, Ian J. Britt, and Marvin A. Tung, in the Journal of Applied Polymer Science, Vol. 82, 2001, pages 1866-1872. The exterior environment evaluated was a south facing wall in Minneapolis, Minn. In the simulation of FIG. 9, the interior relative humidity had a cyclic high of 60%. The initial condition was set to an 80% relative humidity moisture content. The plotted curves in FIG. 9 are from simulated data from the moisture monitor at position 620, the interface of the OSB sheathing with the fiber glass batt.

FIG. 9 shows that in steady state, the moisture content of the OSB sheathing in the configuration including the EVOH/PVOH smart vapor retarder of Table 35 does not rise above 20%. The moisture content of the OSB sheathing in the configuration including a polyamide vapor retarder rises to 21%.

A moisture content above 20% in OSB is more critical than it is in plywood. The reasons are as follows:

OSB is made of “hard wood” chips and fibers. Plywood is made by laminating layers of soft wood. Hard wood has greater concentrations of mold food sources than soft woods.

OSB is a matrix of large quantities of individual wood chips, whereas plywood has an odd number of layers that have been peeled from a log on a lathe (usually 3 to 7 layers). Because wood absorbs moisture at the end grain, OSB reacts to moisture much faster than plywood because OSB has an a virtually unlimited supply of end grain to expose to a water source. More end grain means more and faster water absorption.

Because of the extensive end grain content of the OSB matrix, the degree of swelling is much greater than the swelling in plywood. When OSB swells and dries, it does not regain its original dimensions or design properties. As a result, OSB that has swollen is often required to be removed from a construction. The reason is that the OSB sheathing may be employed in a structural capacity, such as bracing at framed wall corners, and the loss of structural strength could threaten life or safety.

For these reasons, a 1% difference in moisture content of OSB above 20% is critical to expected service life. When performing inspections, technicians are routinely instructed to remove any OSB found to have greater than 20% moisture content or any noticeable degree of swelling. Thus, the 1% difference in moisture content between polyamide and the EVOH/PVOH/EVOH film of Table 35 is a significant difference. FIG. 9 shows how the higher water vapor resistance of the EVOH coextruded or laminated material gives it a superior performance to the polyamide film in this construction.

Although specific examples are provided above for brick and stucco exterior walls, smart vapor retarder materials as described herein (including EVOH, PVOH and/or polyamide, or combinations, coextrusions, laminates, or blends comprising at least one of EVOH, PVOH or polyamide), may be included in a wide variety of wall, floor and ceiling configurations. Such configurations may include a different exterior facing, siding or shingles, different house wraps, different interior walls, and/or different interior wall coverings.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A laminated article, comprising:
a substrate of a building material; and
an adaptive vapor retarder film adhered to the substrate, the film selected as being at least one from the group consisting of:
ethylene vinyl alcohol (EVOH),
EVOH coextruded or laminated with at least a second polymer,
a blended polymer comprising EVOH, or
a combination thereof.

2. The article of claim 1, wherein the film has a thickness of about 0.0004″ to about 0.01″.

3. The article of claim 1, wherein the substrate is at least one of the group consisting of fiber reinforced cellulose materials, synthetic fiber spun fabrics, perforated polyethylene films, polyolefin films, particle board, chip board, oriented strand board, plywood paneling, gypsum board, fiber board, cement board, cementitious wood wool board, calcium silica board, fiber insulation batts, fiber insulation slabs, foam insulation slabs, wall paper, carpet, woven fabrics, and non-woven fabrics, woven and non-woven films, and plastic netting.

4. The article of claim 1, wherein the substrate is a mineral fiber batt or board.

5. The article of claim 1, wherein the substrate is a mineral fiber batt, and the film is an EVOH film.

6. The article of claim 1, wherein the substrate is a mineral fiber batt, and the film is a coextrusion or laminate comprising at least EVOH and the second polymer.

7. The article of claim 6, wherein the second polymer comprises at least one of the group consisting of polyamide, ethylene vinyl acetate (EVA) polyethylene, polypropylene, polyester, polycarbonate, polyurethane, polyvinyl chloride (PVC), and polyvinyl alcohol (PVOH).

8. The article of claim 1, wherein the substrate is a mineral fiber batt, and the film is blended polymer comprising EVOH.

9. The article of claim 1, wherein the film is a coextruded or laminated film comprising EVOH and a second polymer, the film having a minimum permeance of about 0.03 US perms in an ASTM E96 Procedure A Dry Cup test at 25% mean RH and a maximum permeance of about 28 US perms in an ASTM E96 Procedure B wet cup test at 75% mean relative humidity.

10. The article of claim 1, wherein:
the substrate is a mineral fiber batt,
the film is a blended polymer film comprising EVOH, and
the article is installed in an exterior wall structure of a building, with the adaptive vapor retarder film located between the mineral fiber batt and an interior facing surface of the wall structure.

11. A laminated article, comprising:
a batt or blanket of a mineral fiber insulating material; and
an adaptive vapor retarder film adhered to the substrate, the film being at least one of:
ethylene vinyl alcohol (EVOH),
polyvinyl alcohol (PVOH),
a layer of EVOH or PVOH, the layer coextruded or laminated with one or more of nylon or EVA or polyethylene or polypropylene or polyester or polycarbonate or polyurethane or PVC,
EVA coextruded with Nylon,
a blended polymer film comprising EVOH or PVOH, or
a combination thereof.

12. A method of manufacturing a laminated article, comprising:
providing an adhesive to an adaptive vapor retarder film including at least one of:
ethylene vinyl alcohol (EVOH),
EVOH coextruded or laminated with at least a second polymer, and
a blended polymer film comprising EVOH,
contacting the film to at least one surface of a building material, or a combination thereof.

13. The method of claim 12, wherein the substrate is at least one of the group consisting of fiber reinforced cellulose materials, synthetic fiber spun fabrics, perforated polyethylene films, polyolefin films, particle board, chip board, oriented strand board, plywood paneling, gypsum board, fiber board, cement board, cementitious wood wool board, calcium silica board, fiber insulation batts, fiber insulation slabs, foam insulation slabs, wall paper, carpet, woven fabrics, and non-woven fabrics, woven and non-woven films and plastic netting.

14. The method of claim 12, wherein the substrate is a mineral fiber batt or board.

15. A method, comprising:
installing an adaptive vapor retarder in a wall, floor or ceiling of a building, the adaptive vapor retarder including at least one of:
an ethylene vinyl alcohol (EVOH) film,
a layer of EVOH coextruded or laminated with at least a second polymer,
a blended polymer film comprising EVOH; or
a combination thereof.

16. The method of claim 15, wherein the installing step comprises installing a mineral fiber batt with the adaptive vapor retarder thereon in an exterior wall structure of a building, with the adaptive vapor retarder film located between the mineral fiber batt and an interior facing surface of the wall structure.

17. The article of claim 1, wherein:
the substrate is a mineral fiber batt; and
the article is included in a wall further comprising brick, building paper, oriented strand board sheathing, and dry wall.

18. The article of claim 1, wherein:
the substrate is a mineral fiber batt; and
the article is included in a wall further comprising stucco, a polyolefin house wrap, exterior gypsum sheathing, and interior dry wall.

19. A composite article, comprising:
a substrate of a building material; and
an adaptive vapor retarder film fastened to the substrate, the film made from a polymeric material which increases its water vapor permeability when exposed to increasing concentrations of water or water vapor, the film having a permeance of from about 0.03 U.S. perms to about 0.5 U.S. perms in an ASTM E96 Procedure A Dry Cup test at 25% mean relative humidity and a permeance of at least about 1.0 U.S. perm in an ASTM 96 Procedure B wet cup test at 75% mean relative humidity, and a thickness of about 0.0004″ to about 0.01″ (about 0.001 cm to about 0.025 cm).

20. The article of claim 19, wherein the adaptive vapor retarder film has a permeance of at least about 2 U.S. perms in an ASTM 96 Procedure B wet cup test at 75% mean relative humidity.

21. The article of claim 19, wherein the adaptive vapor retarder film has a permeance of at least about 5 U.S. perms in an ASTM 96 Procedure B wet cup test at 75% mean relative humidity.

22. The article of claim 19, wherein the adaptive vapor retarder film has a permeance of at least about 10 U.S. perms in an ASTM 96 Procedure B wet cup test at 75% mean relative humidity.

23. The article of claim 19, wherein the adaptive vapor retarder film has a permeance of at least about 28 U.S. perms in an ASTM 96 Procedure B wet cup test at 75% mean relative humidity.

24. The article of claim 19, wherein the adaptive vapor retarder film has a permeance of about 0.3 U.S. perms in an ASTM 96 Procedure A dry cup test at 25% mean relative humidity.

25. The article of claim 19, wherein the adaptive vapor retarder film has a permeance of about 0.4 U.S. perms in an ASTM E96 Procedure A Dry Cup test at 25% mean relative humidity and a permeance of about 2 U.S. perms in an ASTM 96 Procedure B wet cup test at 75% mean relative humidity.
